(19) United States
(12) Patent Application Publication
(10) Pub. No.: US 2003/0046527 A1
(43) Pub. Date: Mar. 6, 2003

(54) Resolution independent, multi-lingual and multi-style operating system and application user interfaces

(76) Inventor: Hans-Joachim Musuchenborn, Walchwil (CH)

Correspondence Address: DR. HANS-GOACHIM MUSCHENBORN, BUNDESSTR. 7, CH-6304 ZUG, SWITZERLAND, CH-6304, CH

(21) Appl. No.: 10/161,721

(22) Filed: Jun. 5, 2002

(30) Foreign Application Priority Data
Aug. 31, 2001 (DE) 101 42 640.1

(51) Int. Cl. G06F 15/177; G06F 9/24; G06F 9/00

(52) U.S. Cl. 713/1

(57) ABSTRACT

The present invention concerns means and methods to display resolution independent, multi-lingual and/or multi-style operating system and/or application user interfaces on arbitrary programmable units with display units—like personal computers, notebooks, personal digital assistants, (mobile) internet terminals and/or others.

Prior art user interfaces of operating systems and/or application programs are installed only in a single language and a single Look&Feel and—after installation—do not allow to change the language and/or Look&Feel without reinstallation of the operating system and/or application. In addition, prior art operating systems and application programs store, process and display user interface elements in absolute pixels, so that the physical dimensions of the displayed user interface element images shrink with increasing physical resolution of the display unit.

The present invention realizes user interfaces of operating systems and/or application programs, which the user can switch at run-time between multiple languages, and/or Look&Feels and which elements are displayed always in the same—or optionally user definable—physical size, independent of the physical resolution of the display unit. For this purpose, programmable units and/or service units store and provide the resources required to display the user interface in a) all available languages, or b) a single language and translate them upon request automatically into the requested target language, and/or c) the descriptions of all available Look&Feels. The physical dimensions of any part of the user interface elements are stored in units independent of the physical resolution of any display unit. The user has the option to adjust the physical size of any individual user interface element by specification of additional horizontal and vertical scaling factors specific to each individual user interface element.

### CROSS-REFERENCES TO RELATED APPLICATIONS

This invention can be used in any information processing system according to the following related patent applications:

1. U.S. patent application Ser. No. 09/558,435 filed on Apr. 25, 2000 and

2. U.S. patent application Ser. No. 09/740,925 filed on Dec. 19, 2000.

### STATEMENT REGARDING FEDERALLY SPONSORED RESEARCH AND DEVELOPMENT

Not Applicable

### REFERENCES TO ADDITIONAL MATERIAL

Screen displays of the desktops and application programs of prior art operating systems Linux, Solaris, AIX, SCO-Unix, the different versions of Microsoft's Windows, like Windows 3.1, 95, 98, NT 3.51&4.0, 2000, ME, or XP, the different versions of IBM's OS/2, like 2.1, 3.0 Warp, 4.0, the different versions of Apple's MacOS, BeOS, but also real-time and/or embedded operating systems, like RTOS or Windows CE, and others.

### TECHNICAL FIELD

The present invention concerns means and methods to display resolution independent, multi-lingual and/or multi-style operating system and/or application user interfaces on arbitrary programmable units with display units—like personal computers, notebooks, personal digital assistants, (mobile) internet terminals and/or others.

### BACKGROUND OF THE INVENTION

Prior art programmable units, like personal computers, notebooks, personal digital assistants, (mobile) internet terminals and/or others, are controlled by an application independent operating system and an arbitrary number of application programs. In general, the division between operating system and application program is floating. For the purposes of this patent all programs, parts of programs, device drivers, program libraries etc., which are required to use, control and administer—independent of a particular application—any system resources, like CPU(s), core memory, hard drives, I/O-systems, internal and external peripheral devices etc. are counted as part of the operating system, while any programs, parts of programs, program libraries etc., which use the system resources provided by the operating system to realize one or more goals and which are not required for the normal operation of a given machine, are called application programs—or short applications.

Examples of prior art operating systems are different Unix-flavors of different companies, like Linux, Solaris, AIX, SCO-Unix, the different versions of Microsoft's Windows, like Windows 3.1, 95, 98, NT 3.51&4.0, 2000, ME, or XP, the different versions of IBM's OS/2, like 2.1, 3.0 Warp, 4.0, the different versions of Apple's MacOS, BeOS, but also real-time and/or embedded operating systems, like RTOS or Windows CE, and others.

Typical application programs are office applications, like word processors, spreadsheets, communication programs, Internet-browser, e-mail- & FTP-clients, and many others.

Prior art operating systems are controlled by user interfaces—called desktops—, allowing the user and/or system administrator to view and configure the available system resources and to perform application independent work, like listing, copying or deleting of files.

Prior art operating system and application user interfaces are configured during installation in a single language, such that all user interface elements of an installed prior art operating system or application are displayable in a single language only. To change the installed language at least major parts of the operating system or application have to be reinstalled. Prior art operating system user interfaces are lacking the possibility to switch the displayed functional elements of operating system and/or application user interfaces from the current language to another language at run-time. In some cases known to the author, application programs actually have to be installed in the same language as the underlying operating system to run correctly.

The Look&Feel of a user interface is defined by the quality, the presentation, the response and the cooperation of the different user interface control elements—also called controls. The Look&Feel defines which actions the user can perform on which control and how the user interface responds to which user actions. For example, the Look&Feel of a tree control defines, whether a mouse click on a folder opens, selects or displays the folder in another window.

Prior art operation system user interfaces are configured at the time of their installation in exactly one Look&Feel, displaying all controls of an installed operating systems or application program and interpreting the user input in the currently installed Look&Feel only. To modify the installed Look&Feel major parts of the operating system and/or the application programs have to be reinstalled. Prior art operating system user interfaces are lacking the possibility to switch the Look&Feel of the displayed operating system and/or application controls to another Look&Feel at run-time. Because of the limitation to a single Look&Feel, users used to the Look&Feel of other operating systems have to learn and adapt the Look&Feel of a new operating system. This can go as far as that users have to learn the Look&Feel of a new operating system and/or application in specialized training courses.

Prior art operation systems specify the height and width of texts and control elements of their user interfaces in physical pixels to avoid rounding errors in order to generate sharp and crisp images on displays with rough resolutions (with physical resolutions of typically 0.25 mm per pixel). Displays with higher physical resolutions reduce the physical size of the displayed texts and controls by the same factor as the resolution was increased. This can go so far that texts and controls become to small to be readable and/or usedable resulting in a completely unusable machine.

### OBJECT OF THIS INVENTION

The object of this invention is to realize user interfaces of operating systems and/or application programs, which the user can switch at run-time between multiple languages, and/or Look&Feels and which elements are displayed always in the same—or optionally user definable—physical size, independent of the physical resolution of the display unit.

### SUMMARY OF THIS INVENTION

The present invention realizes user interfaces of operating systems and/or application programs, which the user can switch at run-time between multiple languages, and/or Look&Feels and which elements are displayed always in the same—or optionally user definable—physical size, independent of the physical resolution of the display unit. For this purpose, programmable units and/or service units store and provide the resources required to display the user interface in a) all available languages, or b) a single language and translate them upon request automatically into the requested target language, and/or c) the descriptions of all available Look&Feels. The physical dimensions of any part of the user interface elements are stored in units independent of the physical resolution of any display unit. The user has the option to adjust the physical size of any individual user interface element by specification of additional horizontal and vertical scaling factors specific to each individual user interface element.

### BRIEF DESCRIPTION OF FIGURES

FIG. 1 illustrates an incarnation of a programmable unit RE with operating system according to claim 1 for n=3 and languages SP₁=German (Deutsch), SP₂=English and SP₃=Dutch (Nederlands).

FIG. 2 illustrates the timing diagram of a switch-over from language SPᵢ to language SPⱼ in the example of a programmable unit according to claim 1 given in FIG. 1.

FIG. 3 illustrates an incarnation of a programmable unit with operating system according to claim 2 for n=4 and languages SP₁=German (Deutsch), SP₂=English, SP₃=French (Français), SP₄=Italian (Italiano).

FIG. 4 illustrates the timing diagram of a switch-over from language SPᵢ to language SPⱼ in the example of a programmable unit according to claim 2 given in FIG. 3.

FIG. 5 illustrates an incarnation of a programmable unit with operating system according to claim 3 for n=3 and the languages SP₁=German (Deutsch), SP₂=English and SP₃=Dutch (Nederlands), where the system resources TR required for part T are stored in storage SSE on service unit SE in the languages German (Deutsch), English and Dutch.

FIG. 6 illustrates the timing diagram of a switch-over from language SPᵢ to language SPⱼ in the sample incarnation given in FIG. 5.

FIG. 7 illustrates an incarnation of a programmable unit with operating system according to claim 4 for n=4 and the languages SP₁=German (Deutsch), SP₂=English, SP₃=French (Français) and SP₄=Italian (Italiano), where the resources TR required for part T are stored in storage SSE on service unit SE only in a single language SP (in this case English) and, if necessary, are translated automatically into the selected language.

FIG. 8 illustrates the timing diagram of a switch-over from language SPᵢ to language SPⱼ in the sample incarnation given in FIG. 7.

FIG. 9 shows the logon dialog of the operating system OS, in which the user can enter his name and id to logon at the operating system.

Part a) of FIG. 10 illustrates the title “Content: Private\Test-Files”, the main menu with the entries “Directory”, “File” and “Edit” as well as the headings of the columns “Name”, “Size” and “Type” of a table of a sample application program, part b) the main menu of the operating system OS with the language selection, where the individual language entries are displayed in their respective language, so that the language selection is identical in all languages, and part c) the sub-menu “Edit” with the entries “Undo”, “Redo”, “Cut”, “Copy”, “Paste” and “Select All” of the main menu of the same application program as shown in part a).

FIG. 11 illustrates an incarnation of a programmable unit with operating system according to claim 7 for n=3 and the Look&Feels LF₁=Java-Metal, LF₂=Motif and LF₃=Windows, where the descriptions of the Look&Feels Java-Metal, Motif and Windows are stored in storage S of programmable unit RE.

FIG. 12 illustrates the timing diagram of a switch-over from Look&Feel LFᵢ to Look&Feel LFⱼ in the sample incarnation shown in FIG. 11.

FIG. 13 illustrates an incarnation of a programmable unit with operating system according to claim 8 for n=3 and the Look&Feels LF₁=Java-Metal, LF₂=Motif and LF₃=Windows, where the descriptions of the Look&Feels Java-Metal, Motif and Windows are stored in storage SSE on service unit SE and programmable unit RE as well as service unit SE are both physically connected with network N.

FIG. 14 illustrates the timing diagram of a switch-over from Look&Feel LFᵢ to Look&Feel LFⱼ in the sample incarnation shown in FIG. 13.

FIG. 15 shows a directory tree of an application program, which give the user the possibility to select the current working directory.

Part a) of FIG. 16 illustrates the titlebar with the title “Content: Private\Test-Files”, the main menu with the menu entries “Directory”, “File” and “Edit” as well as the column headings “Name”, “Size” and “Type” of a table of a sample application program, part b) the system menu of the operating system OS with the Look&Feel-selection (or style-selection) and part c) the sub-menu “Edit” with the entries “Undo”, “Redo”, Cut”, “Copy”, “Paste” and “Select All” of the main menu of the same application as shown in part a).

FIGS. 17 to 19 illustrate the bitmaps of the logon screens of operating system OS at resolutions of 1024×768 (FIG. 17), 800×600 (FIG. 18) and 640×480 (FIG. 19) pixels. The printed images are of different size, because the printed pixel dimensions are fixed and cannot be adjusted to the actual size of the pixels displayed on display unit A, while each of the logon screen bitmaps shown in FIGS. 17 to 19 fills the entire display area of display unit A.

FIG. 20 directly compares the same section of the logon screen bitmaps shown in FIGS. 17 to 19 in all three resolutions, where the bitmaps were scaled to the same physical printing size, i.e. the 640×480-bitmap was enlarged by a factor 1.6 and the 800×600-Bitmap by a factor 1.28 to the same printing size as the 1024×768-bitmap. The sub-sections on the right each present a small detail of the main image—a circle with shadow and one part of the character “S” of the string “SPINetS”—in 4-fold further enlargement. The image elements have—up to an accuracy limited by their respective digitalization error—the same physical size as well as—obvious by the different edge structures—with increasing resolution an increasing geometric accuracy.

### DETAILED DESCRIPTION OF THIS INVENTION

The present invention overcomes the prior art by programmable machines with operating systems according to one of the independent claims 1 to 5, 7 to 8 and 10 to 13 and according to one of the claims dependent on claims 1 to 5, 7 to 8 and 10 to 13.

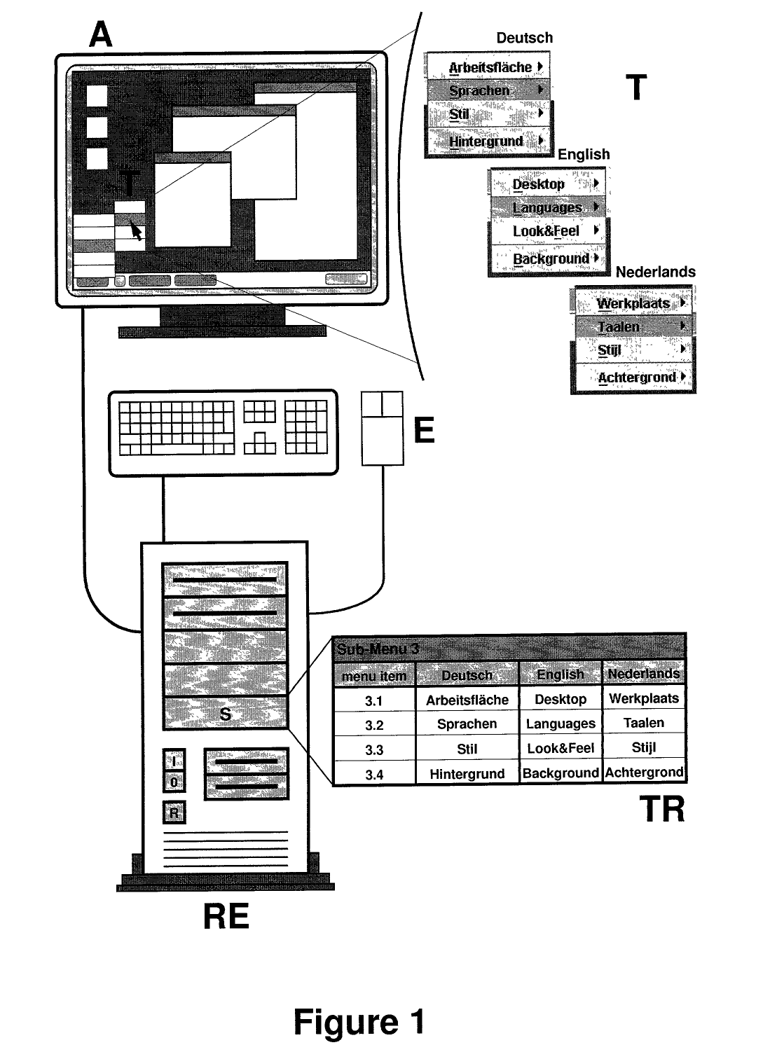

A programmable unit RE with operating system and user interface according to claim 1 allows to switch the user interface elements between at least two languages SPᵢ and SPⱼ. FIG. 1 illustrates an incarnation of a programmable unit RE with operating system according to claim 1 for n=3 and languages SP₁=German (Deutsch), SP₂=English and SP₃=Dutch (Nederlands). After installation of operating system OS unit RE stores in storage S the system resources R required for part T in the languages German (Deutsch), English and Dutch, so that part T of the user interface elements of operating system OS and/or application programs AP₁, . . . , APₐₚ, managed by operating system OS and visible on display unit A, can be displayed in one of the languages German (Deutsch), English and Dutch selected by the user. Part T can be for example—but not exclusively—a menu, a sub-menu (like in FIG. 1), a menu entry, a dialog window, a button, a single- or multi-line text field, a label, an image with text or another user interface element.

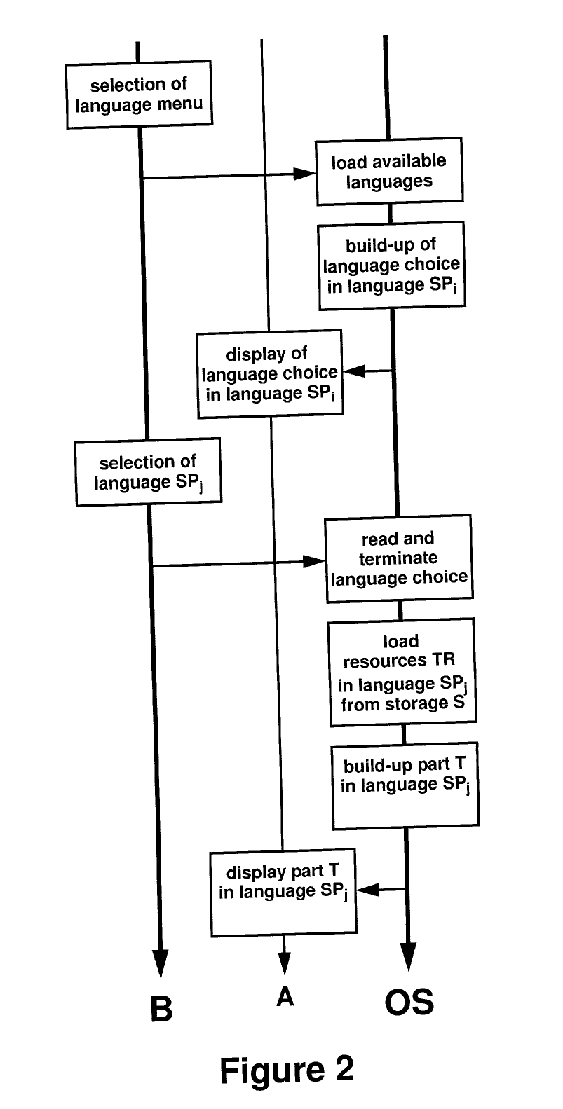

FIG. 2 illustrates the timing diagram of a switch-over from language SPᵢ to language SPⱼ in the example of a programmable unit according to claim 1 given in FIG. 1. Initially user B activates the language menu by choosing for example the sub-menu “Language” of the system menu. Then the operating system OS loads all for part T in storage S available languages, builds-up the language selection—for example in the form of a sub-menu—in the currently active language SPᵢ and displays the language selection in language SPᵢ on display unit A. After selection of language SPⱼ by user B operating system OS loads resources TR required to display part T in language SPⱼ from storage S, builds-up part T in the new language SPⱼ and displays part T in language SPⱼ on display unit A.

The entries of the individual languages in the language selection can also be displayed in their respective language (see also FIG. 10b) with the advantage, that the language selection is identical in all languages and therefor does not have to be translated.

During switching to another language the geometry of part T may be adapted automatically, including the position and size, the writing direction (left to right, right to left, top to bottom or bottom to top) and the character set of the appropriate alphabet for the active and passive user interface elements, to visibly display all user interface elements according to the conventions of the newly selected language.

The main advantages of a programmable unit with operating system according to claim 1 versus prior art, are

1. that for worldwide distribution a software producer needs to support only a single version of the operating system and the user interface,

2. that the geometry of part TR is adapted automatically to the resources in the new language, so that the software localization is reduced mainly to the translation of the texts used in the user interface elements, such that labor intensive manual adoption of the graphical layout to different languages becomes obsolete,

3. that additional languages can be installed at run-time of the operating system and without modifications of the operating system software, such that after installation the additional language is added immediately to the language selection offered to the user and the user can switch at least part T to the newly installed language at run-time of the operating system and/or the application programs AP₁, . . . , APₐₚ—without terminating his operation system session and without re-boot.

Programmable units with operating systems according to claim 2 store part TR only in a single language SP in storage S. At the same time unit RE and/or operating system OS comprise means to translate upon request at least part TR from language SP to another requested language. Compared to claim 1 a programmable unit according to claim 2 has the advantage, that the manual software localization becomes completely obsolete and at the same time only a single language version of the operating system has to be developed and maintained.

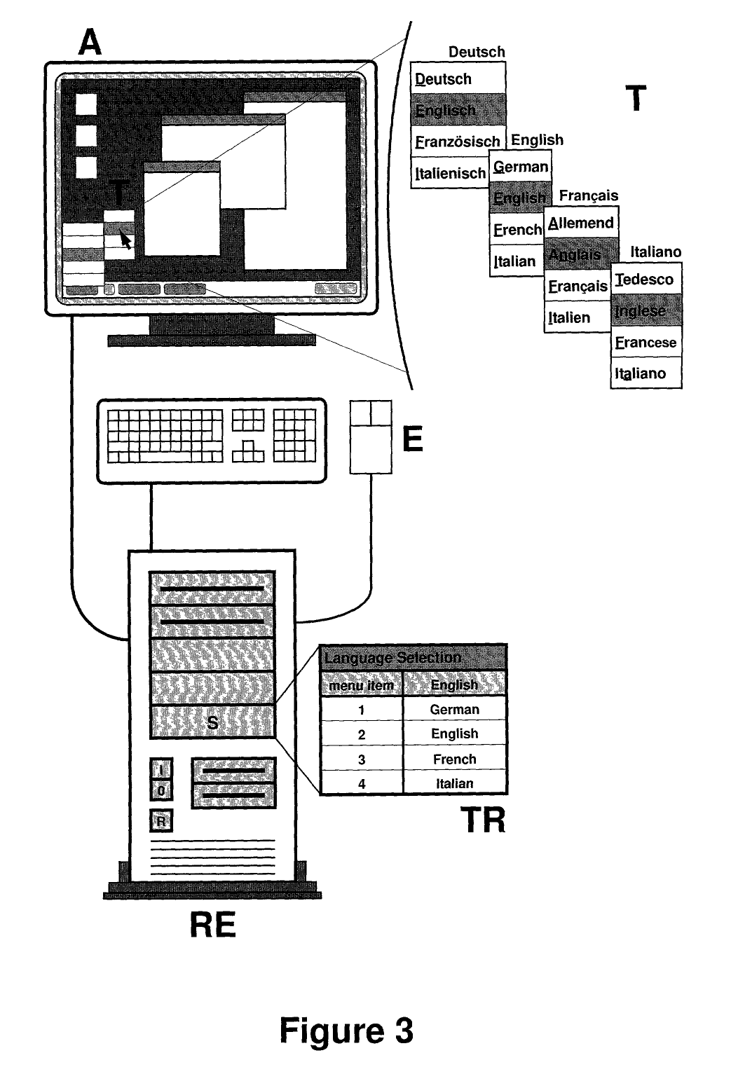

FIG. 3 illustrates an incarnation of a programmable unit with operating system according to claim 2 for n=4 and languages SP₁=German (Deutsch), SP₂=English, SP₃=French (Français), SP₄=Italian (Italiano). After installation of operating system OS, unit RE stores in storage S system resources required for part TR in English only and, if necessary, translates system resources required for part TR into the selected language, so that part T of the user interface elements of operating system OS and/or application programs AP₁, . . . , APₐₚ, managed by operating system OS and visible on display unit A, can be displayed in one of the languages German (Deutsch), English, French and Italian selected by the user. Part T can be for example—but not exclusively—a menu, a sub-menu (like in FIG. 3), a menu entry, a dialog window, a button, a single- or multi-line text field, a label, to image with text or another user interface element.

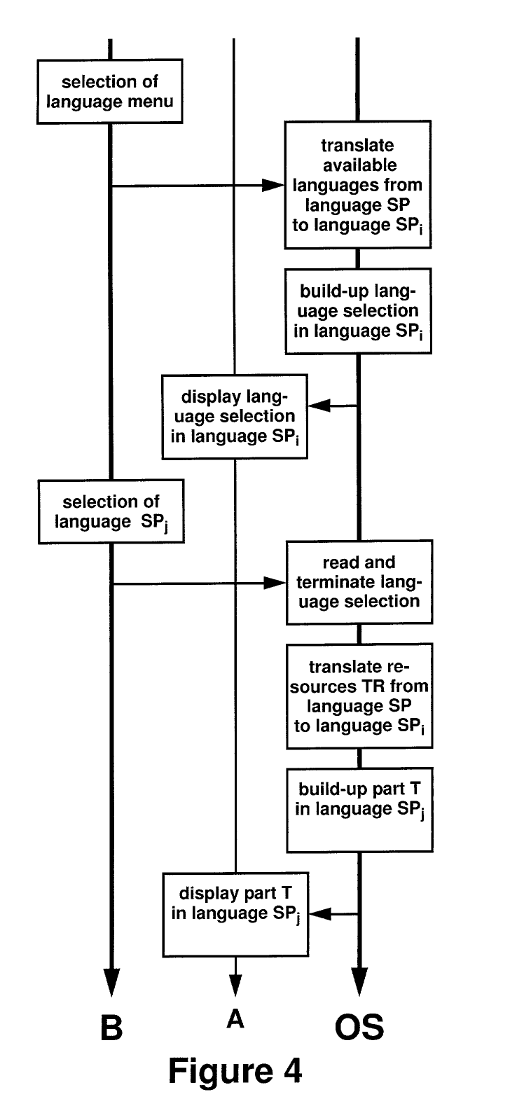

FIG. 4 illustrates the timing diagram of a switch-over from language SPᵢ to language SPⱼ in the example of a programmable unit according to claim 2 given in FIG. 3. Initially user B activates the language menu by choosing for example the sub-menu “Language” of the system menu. If SPᵢ is not English, operating system OS translates all languages available for part T from English to the currently active language SPᵢ, builds-up the language selection—for example in form of a sub-menu—in the currently active language SPᵢ and displays the language selection in the language SPᵢ on display unit A. After selection of language SPⱼ by user B operating system OS loads the English resources TR required to display part T form storage S, —if SPⱼ is not English—translates all texts contained in resources TR from English to language SPⱼ, builds-up part T in the new language SPⱼ and displays part T in the language SPⱼ on display unit A.

The entries of the individual languages in the language selection can also be displayed in their respective language (see also FIG. 10b) with the advantage, that the language selection is identical in all languages and therefor does not have to be translated.

Programmable units with operating systems according to one of the claims 3 to 5 allow to request and receive at least part TR of the required resources R of at least one part T of the user interface elements of operating system OS and/or application programs AP₁, . . . , APₐₚ, managed by operating system OS and visible on display unit A, from a service unit SE reachable from unit RE via network N and to display in the selected language on display unit A, where the claims differ in the storage of all available language versions (claim 3), the storage of at least one language version and the automatic translation by service unit SE into the selected and requested language (claim 4) as well as the storage of at least one language version by service unit SE and the automatically translation by said unit RE into the selected language (claim 5). In claims 3 to 5 it is not important in which sub-network programmable unit RE and service unit SE are located, with which protocol whether connection less or connection oriented the communication between programmable unit RE and service unit SE is performed, how a potential connection between programmable unit RE and service unit SE is established, and over how many switches, hubs, physical and/or logical router, proxies or sub-nets the request from programmable unit RE to service unit SE and the reply of service unit SE to programmable unit RE are transmitted, as long as service unit SE and programmable unit RE can communicate as required by claims 3 to 5. For example, programmable unit RE and service unit SE could be located in the same or different network segment(s), or be connected with the Internet or internet-like intra- or extranets and communicate via one or several routes.

If programmable unit RE with operating system according to one of the claims 3 to 5 additionally comprises means to receive after a change of part TR in the language currently displayed on programmable unit RE at least one message containing the new version of part TR, programmable unit RE is actually able to update the display of part T automatically according to the new version, whereby it is not important how and/or with which protocol programmable unit RE is informed about the change of part T. This could be performed for example

1. by regular polling of service unit SE by programmable unit RE, or

2. by registering a trigger on at least resources TR for programmable unit RE at service unit SE and automatic update notifications of any modifications of resources TR from service unit SE to programmable unit RE, or

3. an asynchronous update notification (without previous registered trigger) upon modification of resources TR from service unit SE to programmable unit RE.

Neither is it important in which manner and/or with which protocol and/or format programmable unit RE receives the updated resources TR from service unit. This could be performed for example

1. by a synchronous or asynchronous transmission of the modified resources TR together with the update notification from service unit SE to programmable unit RE, or

2. —after reception of the update notification—by explicit request of the modified resources TR from programmable unit RE to service unit SE followed by the transmission of the modified resources TR from service unit SE to programmable unit RE, or

3. —after reception of the update notification—by a separate synchronous or asynchronous transmission of the modified resources TR from service unit SE to programmable unit RE,

where programmable unit RE in the case of asynchronous message transmission from service unit SE to programmable unit RE has to comprise additional means to receive and process asynchronous messages from service unit SE.

Compared to programmable units with operating systems according to one of the claims 1 and 2 programmable units with operating systems according to one of the claims 3 to 5 have the advantage, that the administration of the different languages can be performed simultaneously for one or multiple programmable units at a single central location on service unit SE.

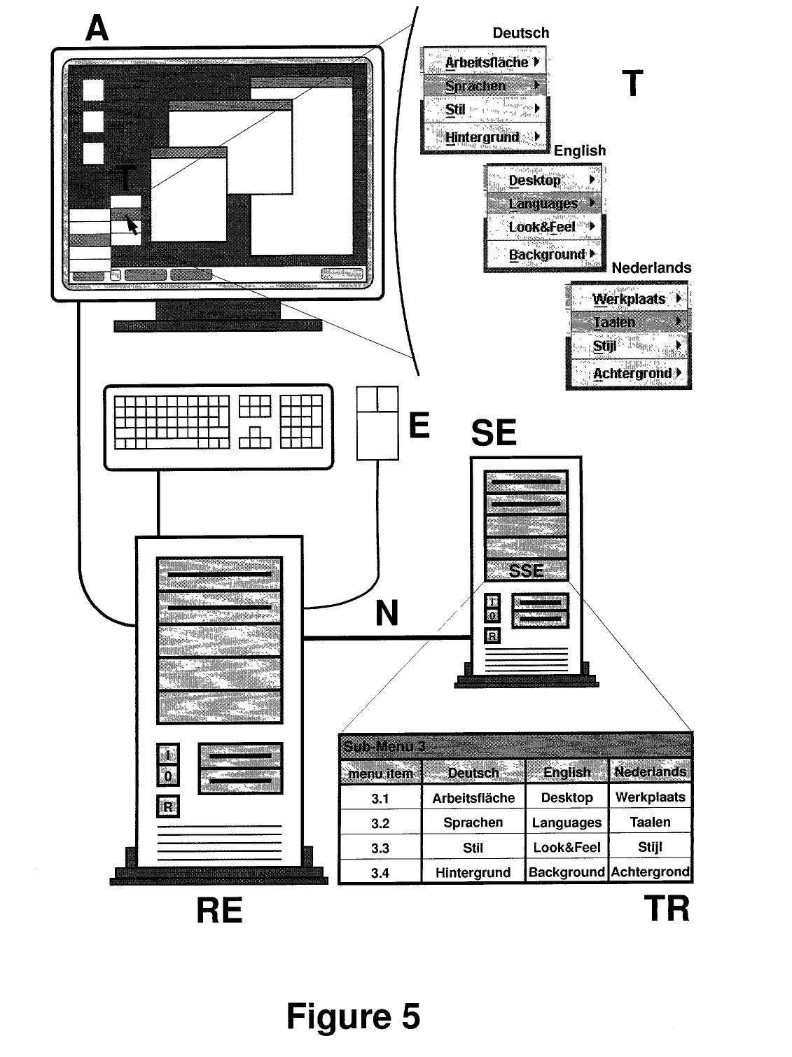

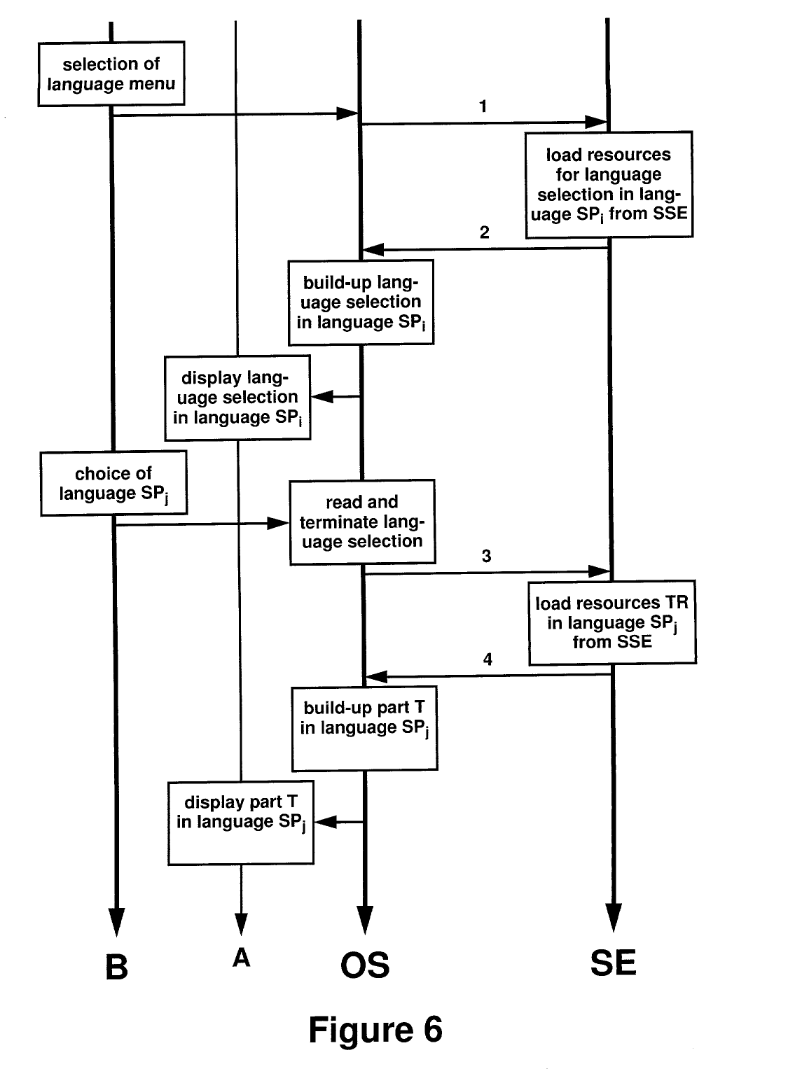

FIG. 5 illustrates an incarnation of a programmable unit with operating system according to claim 3 for n=3 and the languages SP₁=German (Deutsch), SP₂=English and SP₃=Dutch (Nederlands), where the system resources TR required for part T are stored in storage SSE on service unit SE in the languages German (Deutsch), English and Dutch, where programmable unit RE as well as service unit SE are both physically connected to network N. FIG. 6 illustrates the timing diagram of a switch-over from language SPᵢ to language SPⱼ in the sample incarnation given in FIG. 5: Initially, user B activates the language selection by selecting for example with input unit E in system menu the sub-menu “languages”, whereupon operating system OS in message 1 requests the resources required to display the language selection from service unit SE in language SPᵢ, service unit SE loads the resources required to display the language selection in language SPᵢ from storage SSE and in message 2 transmits the resources required to display the language selection in language SPᵢ to programmable unit RE, operating system OS receives from service unit SE the transmitted resources, builds-up the language selection in language SPᵢ and displays the language selection in language SPᵢ on display unit A, such that user B can select with input unit E language SPⱼ, whereupon operating system OS in message 3 requests resources TR required to display part T from service unit SE in language SPⱼ, service unit loads resources TR in language SPⱼ from storage SSE and in message 4 transmits resources TR in language SPⱼ to programmable unit RE, operating system OS receives resources TR in language SPⱼ from service unit SE, builds-up part T in language SPⱼ and displays part T in language SPⱼ on display unit A.

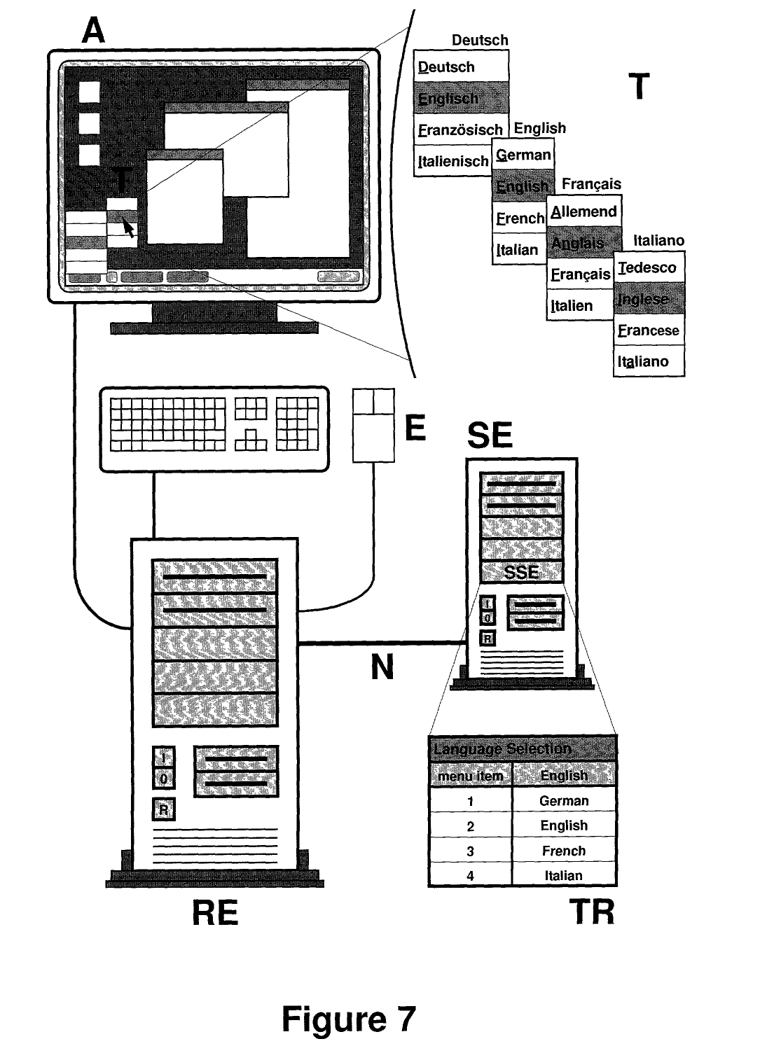

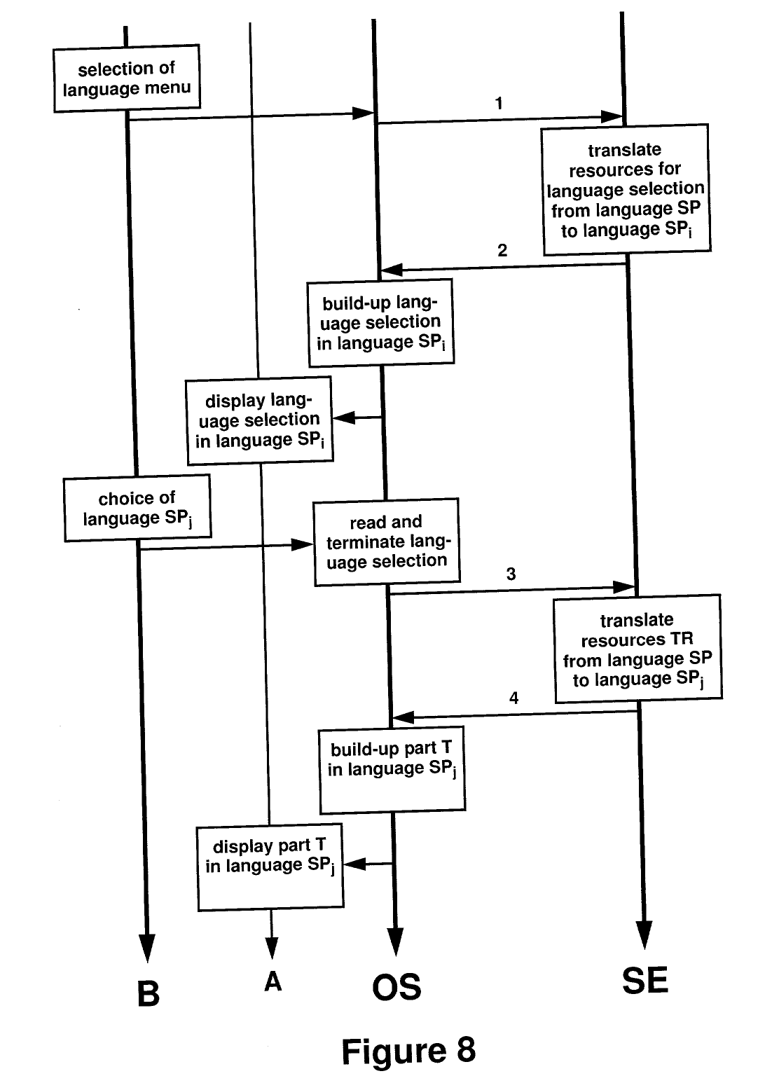

FIG. 7 illustrates an incarnation of a programmable unit with operating system according to claim 4 for n=4 and the languages SP₁=German (Deutsch), SP₂=English, SP₃=French (Français) and SP₄=Italian (Italiano), where the resources TR required for part T are stored in storage SSE on service unit SE only in a single language SP (in this case English) and programmable unit RE as well as service unit SE are both physically connected to network N. FIG. 8 illustrates the timing diagram of a switch-over from language SPᵢ to language SPⱼ in the sample incarnation given in FIG. 7: Initially, user B activates the language selection by selecting for example with input unit E in system menu the sub-menu “languages”, whereupon operating system OS in message 1 requests the resources required to display the language selection from service unit SE in language SPᵢ, service unit SE loads the requested resources required to display the language selection in English, —if the requested language SPᵢ is not English—translates all texts contained in the loaded resources from English to the requested language SPᵢ, and in message 2 transmits the resources required to display the language selection in language SPᵢ to programmable unit RE, operating system OS receives from service unit SE the transmitted resources, builds-up the language selection in language SPᵢ and displays the language selection in language SPᵢ on display unit A, such that user B can select with input unit E language SPⱼ, whereupon operating system OS in message 3 requests resources TR required to display part T from service unit SE in language SPⱼ, service unit loads resources TR in English from storage SSE, —if the requested language SPⱼ is not English—translates all texts contained in the loaded resources TR from English to the requested language SPⱼ, and in message 4 transmits resources TR in language SPⱼ to programmable unit RE, operating system OS receives resources TR in language SPⱼ from service unit SE, builds-up part T in language SPⱼ and displays part T in language SPⱼ on display unit A.

A programmable unit RE with operating system according to claim 5 can be realized as shown in FIG. 7, where the translation into the selected language SPᵢ is performed by programmable unit RE rather than service unit SE.

The entries of the individual languages in the language selection of a programmable unit with operating system according to one of the claims 3 to 5 can also be displayed in their respective language (see also FIG. 10b) with the advantage, that the language selection is identical in all languages and does not have to be translated. In this case the first transaction between programmable unit RE and service unit SE (messages 1&2) have to be performed only once and can be omitted for the following language selections.

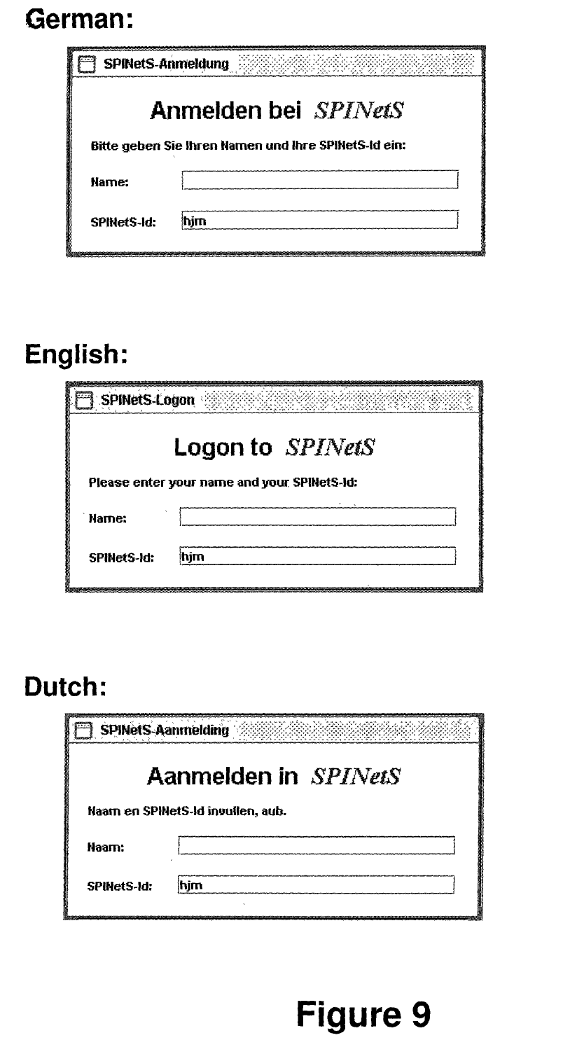

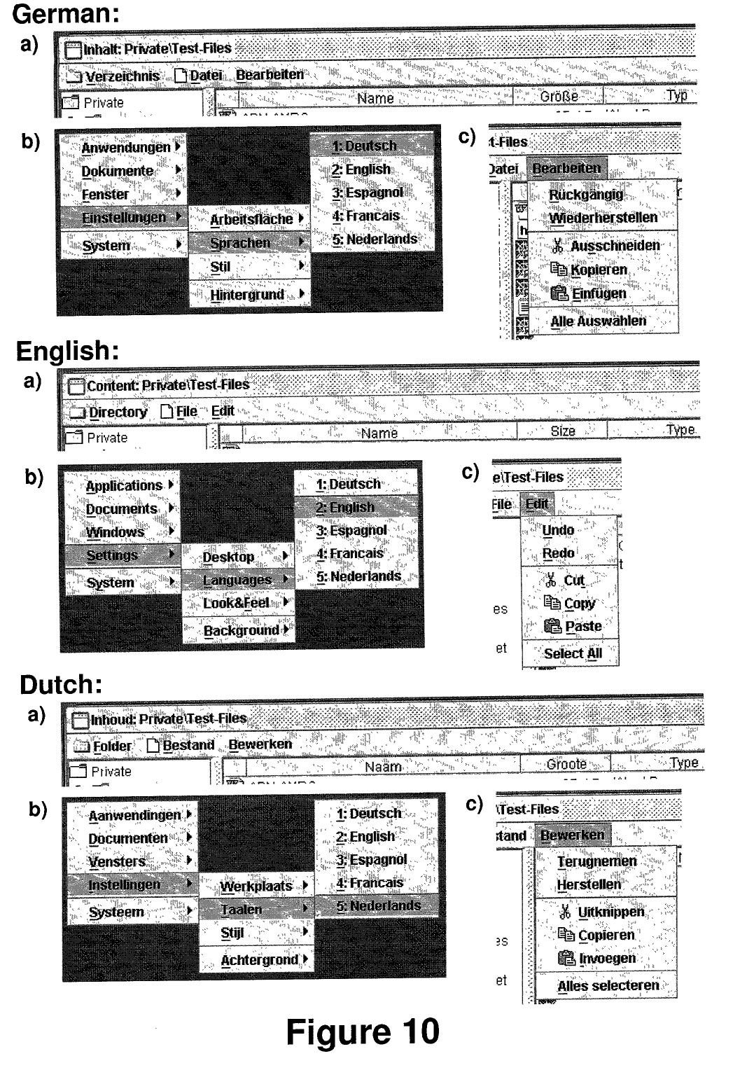

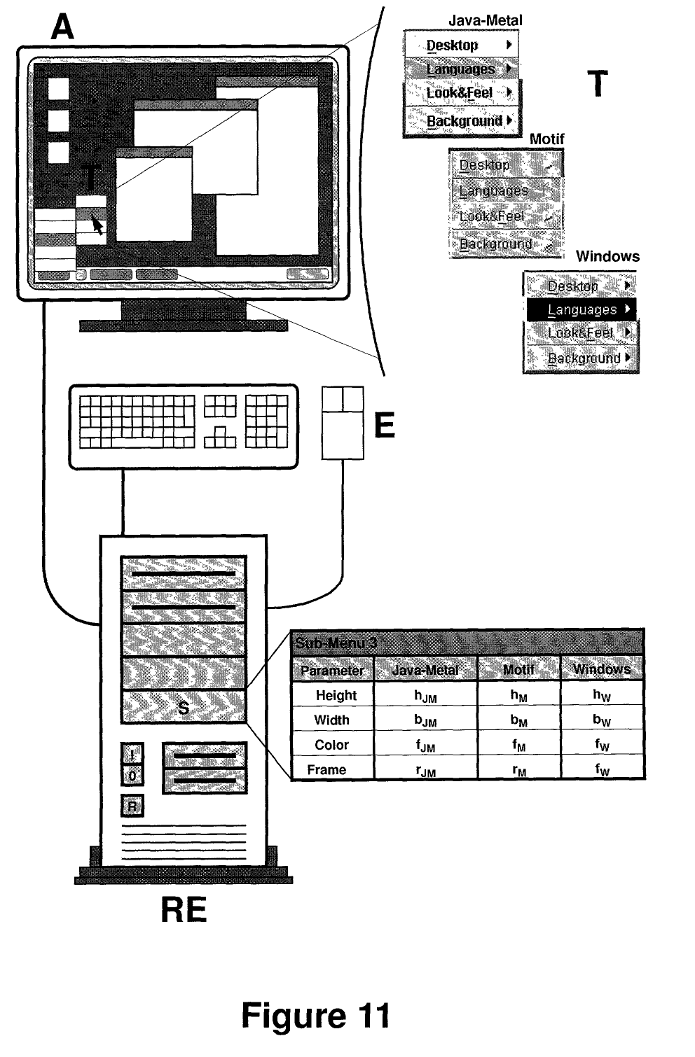

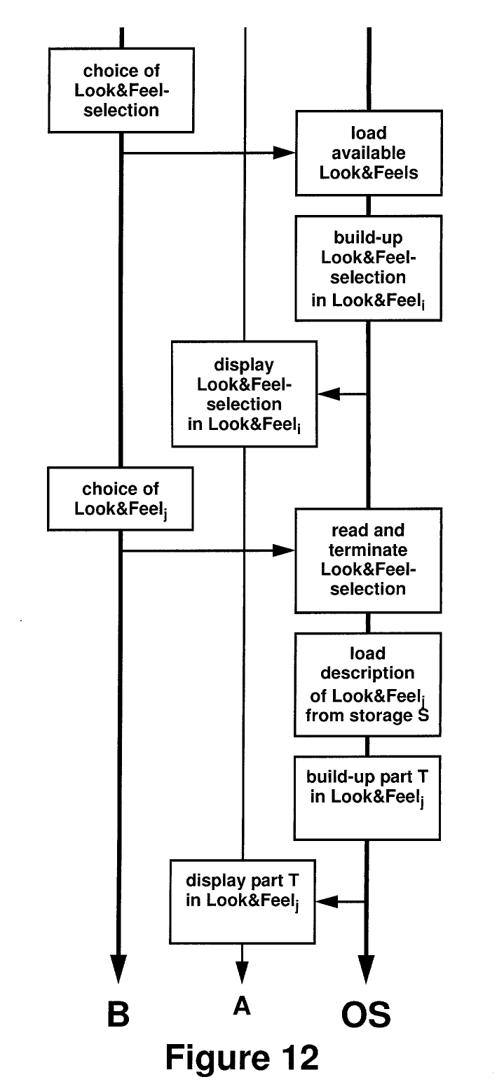

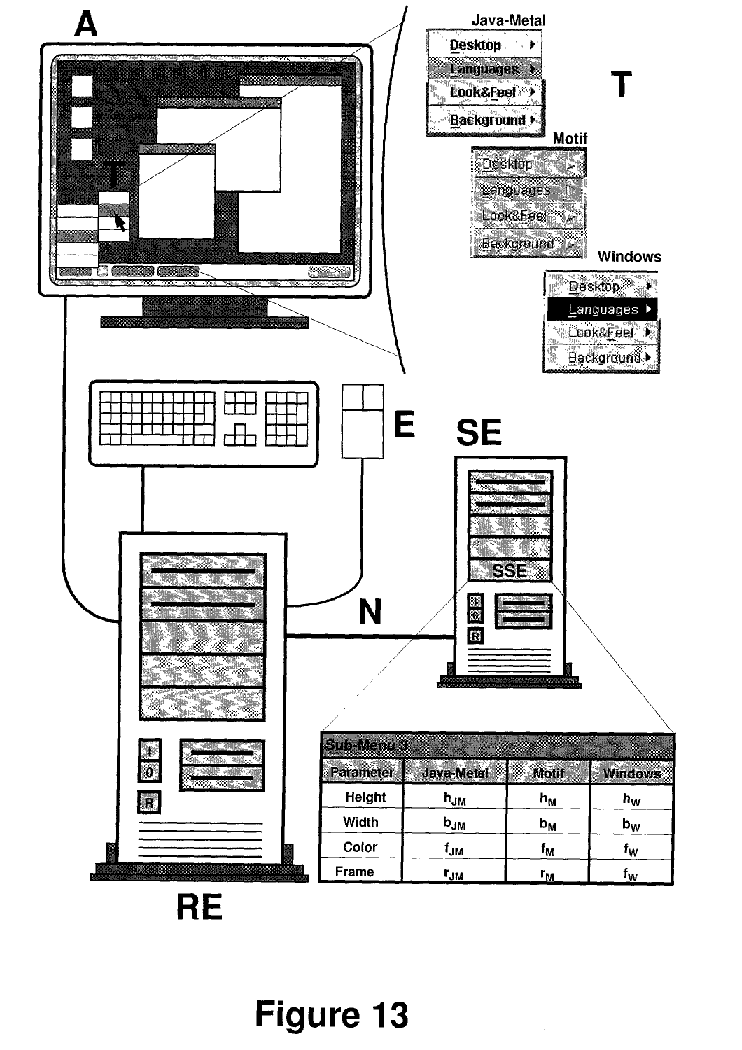

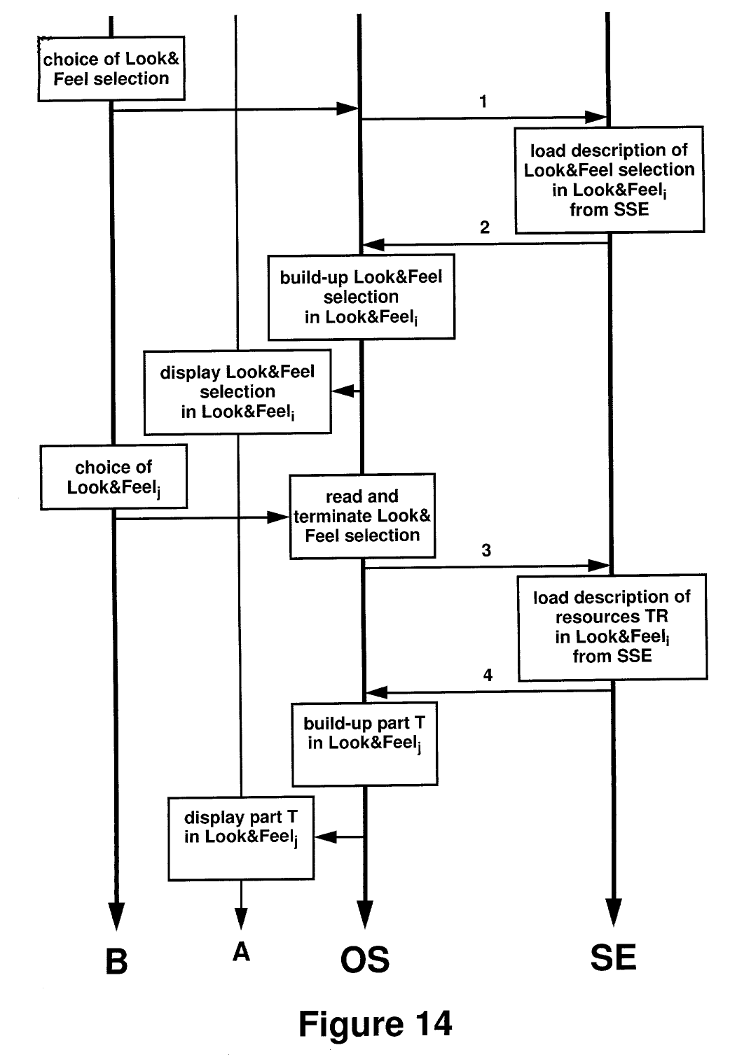

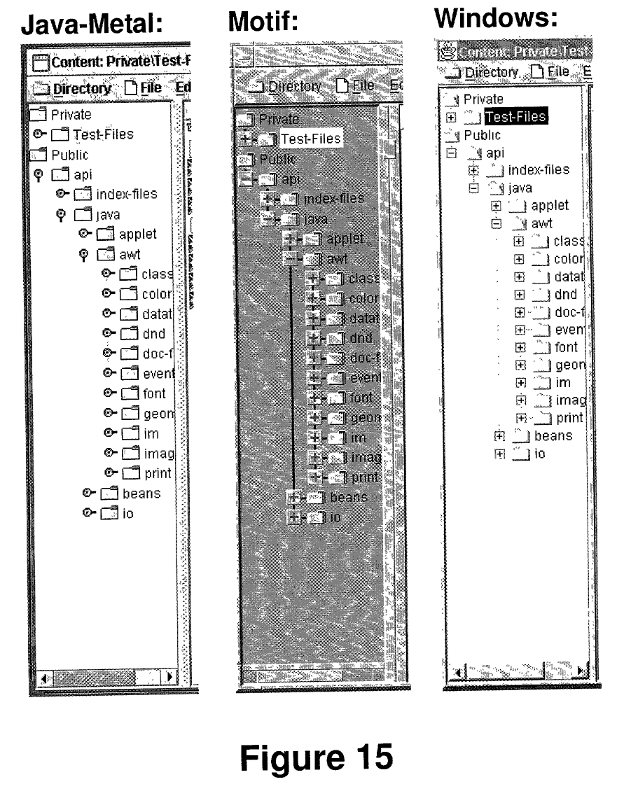

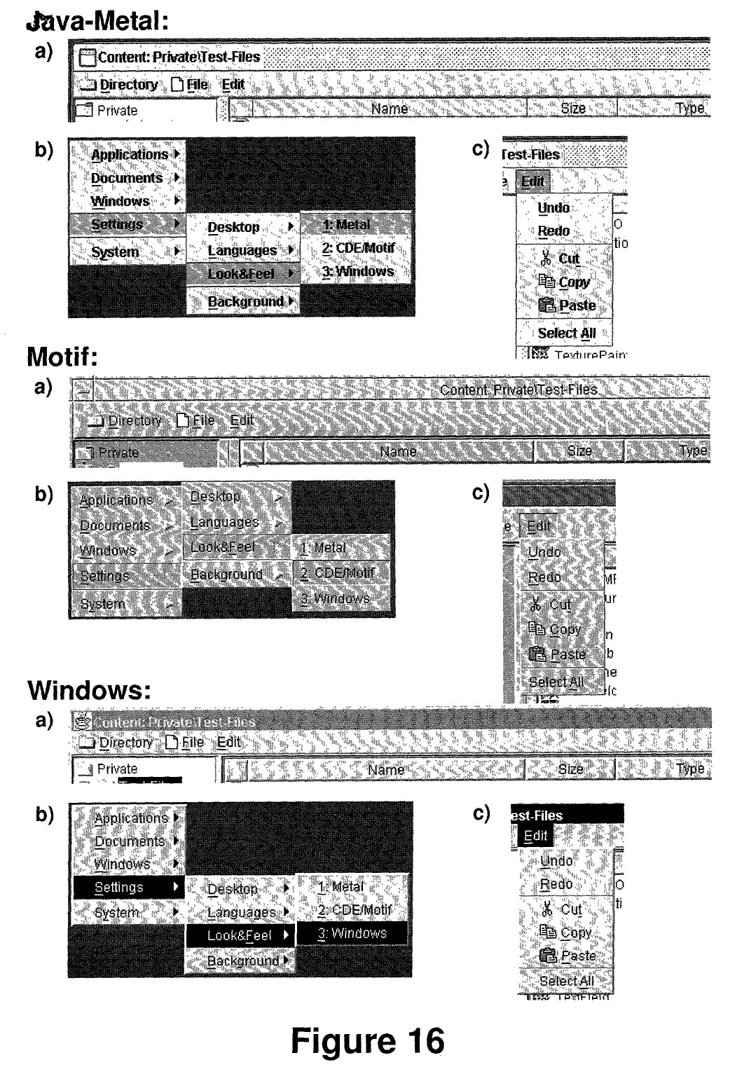

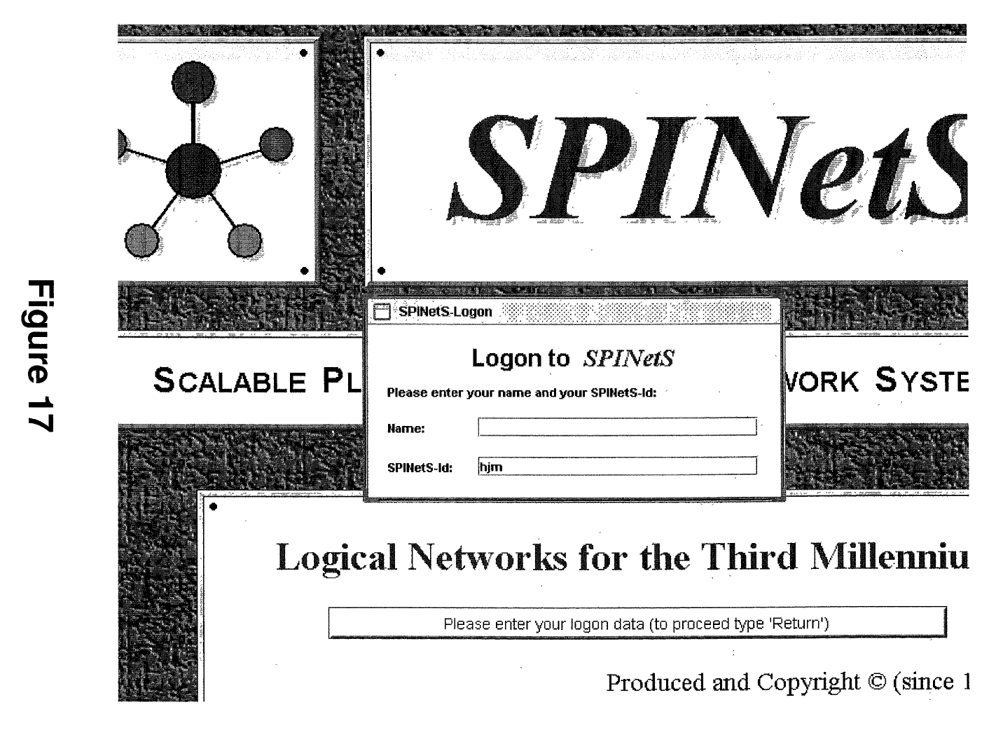

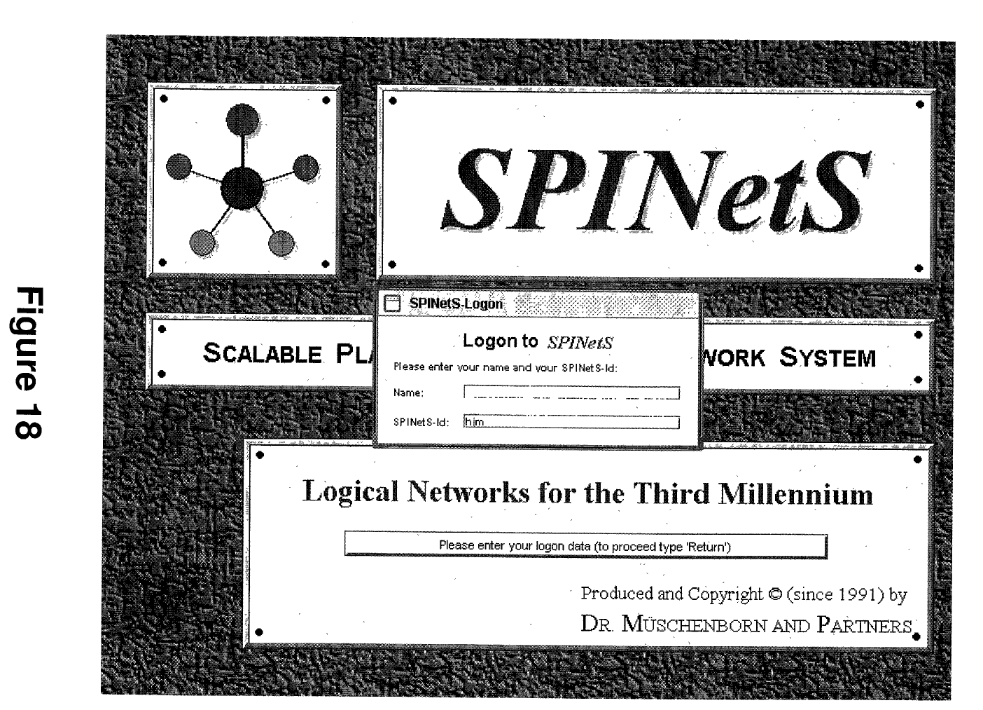

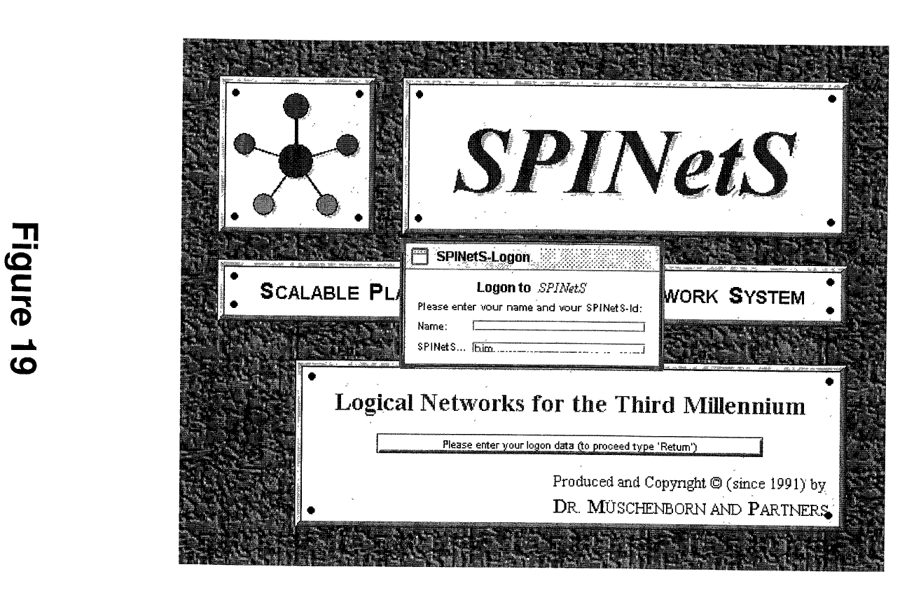

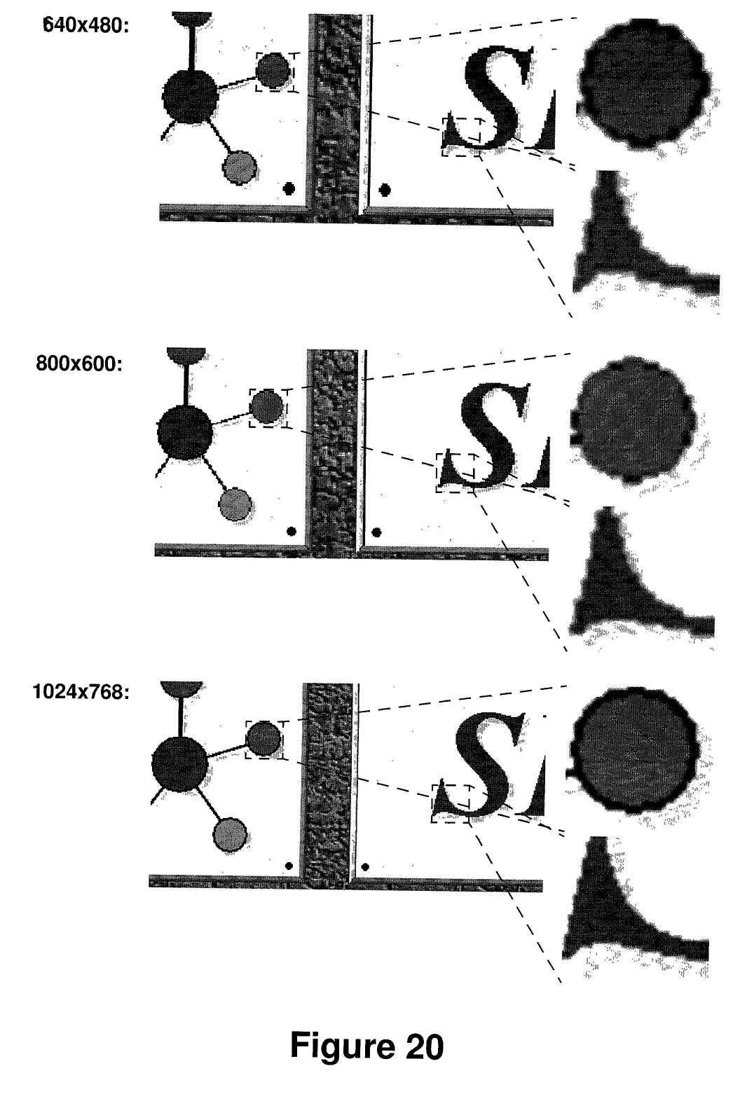

FIGS. 9 and 10 illustrate different parts T, which can be switched at run-time of the operating system and the application programs between the languages German (Deutsch), English or Dutch, where the language switch-over requires neither to terminate the operating system nor the application program, nor the user session at the operating system (log-off). FIG. 9 shows the logon dialog of the operating system OS, in which the user can enter his name and id to logon at the operating system. Part a) of FIG. 10 illustrates the title “Content: Private\Test-Files”, the main menu with the entries “Directory”, “File” and “Edit” as well as the headings of the columns “Name”, “Size” and “Type” of a table of a sample application program, part b) the main menu of the operating system OS with the language selection, where the individual language entries are displayed in their respective language, so that the language selection is identical in all languages, and part c) the sub-menu “Edit” with the entries “Undo”, “Redo”, “Cut”, “Copy”, “Paste” and “Select All” of the main menu of the same application program as shown in part a), where only the labels and control elements of the user interface are translated into the different languages and not the content. For example the part “Private\Test-Files” in the title bar represent the directory currently displayed in the table of the application program and “Private” the directory of private files, which both are interpreted as content and not translated.

Special incarnations of a programmable unit with operating system according to one of the claims 1 to 5 switch at least part T from the current language to the newly selected language SPᵢ resp. SPⱼ immediately after a new language selection of the user at run-time of the operating system OS and/or application programs AP₁, . . . , APₐₚ and do neither require the user to log-off, nor to terminate the operating system nor to terminate any application program AP₁, . . . , APₐₚ (claim 6).

A programmable unit RE with operating system according to claim 7 allows to switch the Look&Feel of at least one part T of the user interface elements of operating system OS and/or application programs AP₁, . . . , APₐₚ, managed by operating system OS and visible on display unit A, at least between two different Look&Feels LFᵢ and LFⱼ. The Look&Feel comprises the graphical design (look) and responsiveness (feel) of at least one part T of the user interface elements of operating system OS and/or application programs AP₁, . . . , APₐₚ, managed by operating system OS and visible on display unit A, like for example: the desktop, the frame window, the title bar, the system menu, the buttons to control the window size, the application menu, scrollbars, dialogs, lists, tables, buttons, trees, texts, entry fields, labels, text sizes etc.

Compared to prior art the advantages of a programmable unit with operating system according to claim 7 are,

1. a highly reduced effort to train resp. retrain users, who were previously trained—potentially on another programmable unit running a prior art operating system—in at least one Look&Feel, whereby

2. the fix relationship between producer of the programmable unit and the operating system with its proprietary Look&Feel becomes obsolete, and whereby

3. the competition between producers of programmable units and operating systems is strengthened leading for the client on the long run to lower prices.

FIG. 11 illustrates an incarnation of a programmable unit with operating system according to claim 7 for n=3 and the Look&Feels LF₁=Java-Metal, LF₂=Motif and LF₃=Windows, where the descriptions of the Look&Feels Java-Metal, Motif and Windows are stored in storage S of the programmable unit RE. FIG. 12 illustrates the timing diagram of a switch-over from Look&Feel LFᵢ to Look&Feel LFⱼ in the sample incarnation shown in FIG. 11. Initially, user B activates the Look&Feel-selection by selecting with input unit E for example in system menu the sub-menu “Style”, whereupon operating system OS loads, if necessary, the description of Look&Feel LFᵢ from storage S, builds-up the Look&Feel-selection in Look&Feel LFᵢ and displays the Look&Feel-selection in Look&Feel LFᵢ on display unit A, so that user B can select with input unit E Look&Feel LFⱼ, whereupon operating system OS loads, if necessary, the description of Look&Feel LFⱼ from storage S, builds-up part T in Look&Feel LFⱼ and displays part T in Look&Feel LFⱼ on display unit A.

A programmable unit RE with operating system according to claim 8 allows to request and receive the description of the graphical design (look) and the response characteristics (feel) of a selectable Look&Feel LFᵢ resp. LFⱼ from service unit SE and to display at least part T of the user interface elements of operating system OS and/or application programs AP₁, . . . , APₐₚ, managed by operating system OS and visible on display unit A, in Look&Feel LFᵢ resp. LFⱼ on display unit A and to interpret at least the user input via input unit E for part T with Look&Feel LFᵢ resp. LFⱼ, whereby it is insignificant, in which sub-network programmable unit RE and service unit SE are located, which—connection less or connection oriented—protocol is used for the communication between programmable unit RE and service unit SE, how a potential connection is established between programmable unit RE and service unit SE, and over how many switches, hubs, physical and/or logical routers, proxies or sub-networks the request from programmable unit RE to service unit SE and the reply from service unit SE to programmable unit RE is routed, as long as service unit SE and programmable unit RE are able to communicate between each other as required in claim 8. For example programmable unit RE and service unit SE can be located in the same or different network segment(s), or be connected with the Internet or internet-like intra- or extranets and communicate via a single or multiple routes.

Compared to a programmable unit RE with operating system according to claim 7 a programmable unit RE with operating system according to claim 8 has the advantage, that the descriptions of the different Look&Feels can be installed and maintained for one or multiple programmable units on a single central service unit SE.

If a programmable unit RE with operating system according to claim 8 comprises additional means to receive, after an amendment of the description of a Look&Feel stored in storage SSE and currently used on programmable unit RE, in at least one message the new description of the amended Look&Feel, programmable unit RE can update the displayed Look&Feel automatically to the amended description, whereby it is not important how and/or with which protocol programmable unit RE is informed about the change of a given Look&Feel. This could be performed for example

1. by regular polling of service unit SE by programmable unit RE, or

2. by registering a trigger on the currently used Look(s)&Feel(s) by programmable unit RE at service unit SE and automatic update notification from service unit SE to programmable unit RE, if one of the triggered Look(s)&Feel(s) are changed, or

3. an asynchronous update notification (without previous registered trigger) upon modification of a Look&Feel, currently used by programmable unit RE, from service unit SE to programmable unit RE.

Neither is it important in which manner and/or with which protocol and/or format programmable unit RE receives the updated Look&Feel from service unit SE. This could be performed for example

1. by a synchronous or asynchronous transmission of the modified Look&Feel together with the update notification from service unit SE to programmable unit RE, or

2. —after reception of the update notification—by explicit request of the modified Look&Feel from programmable unit RE to service unit SE followed by the transmission of the modified Look&Feel from service unit SE to programmable unit RE, or

3. —after reception of the update notification—by a separate synchronous or asynchronous transmission of the modified Look&Feel from service unit SE to programmable unit RE,

where programmable unit RE in the case of asynchronous message transmission from service unit SE to programmable unit RE has to comprise additional means to receive and process asynchronous messages from service unit SE.

FIG. 13 illustrates an incarnation of a programmable unit with operating system according to claim 8 for n=3 and the Look&Feels LF₁=Java-Metal, LF₂=Motif and LF₃=Windows, where the descriptions of the Look&Feels Java-Metal, Motif and Windows are stored in storage SSE on service unit SE and programmable unit RE as well as service unit SE are both physically connected with network N. FIG. 14 illustrates the timing diagram of a switch-over from Look&Feel LFᵢ to Look&Feel LFⱼ in the sample incarnation shown in FIG. 13. Initially, user B activates the Look&Feel-selection by selecting with input unit E for example in the system menu the sub-menu “Style”, whereupon operating system OS in message 1 requests, if necessary, the description of Look&Feel LFᵢ of the Look&Feel-selection from service unit SE, service unit SE loads the description of Look&Feel LFᵢ of the Look&Feel-selection from storage SSE and sends in message 2 the description of the Look&Feel LFᵢ of the Look&Feel-selection to programmable unit RE, operating system OS receives from service unit SE the description the Look&Feel LFᵢ of the Look&Feel-selection, builds-up the Look&Feel-selection in Look&Feel LFᵢ and displays the Look&Feel-selection in Look&Feel LFᵢ on display unit A, such that user B can select with input unit E Look&Feel LFⱼ, whereupon operating system OS in message 3 requests, if necessary, the description of the Look&Feel of part T in Look&Feel LFⱼ or the description of Look&Feel LFⱼ from service unit SE, service unit SE loads the description of the Look&Feel of part T in Look&Feel LFⱼ or the description of Look&Feel LFⱼ from storage SSE and sends in message 4 the description of the Look&Feel of part T in Look&Feel LFⱼ or the description of the Look&Feel LFⱼ to programmable unit RE, operating system OS receives the description of the Look&Feel of part T in Look&Feel LFⱼ or the description of Look&Feel LFⱼ from service unit SE, builds-up part T in Look&Feel LFⱼ and displays part T in Look&Feel LFⱼ on display unit A.

Special incarnations of a programmable unit with operating system according to one of the claims 7 to 8 switch at least part T from the current Look&Feel to the newly selected Look&Feel LFᵢ resp. LFⱼ immediately after a new Look&Feel selection of the user at run-time of the operating system OS and/or application programs AP₁, . . . , APₐₚ and do neither require the user to log-off, nor to terminate the operating system nor to terminate any application program AP₁, . . . , APₐₚ (claim 9).

FIGS. 15 and 16 illustrate further examples of different parts T, which can be switched at run-time of the operating system and the application programs between the Look&Feels Java-Metal, Motif or Windows, where the user neither has to terminate the operating system nor the application programs nor his operating system session. FIG. 15 shows a directory tree of an application program, which give the user the possibility to select the current working directory. Part a) of FIG. 16 illustrates the titlebar with the title “Content: Private\Test-Files”, the main menu with the menu entries “Directory”, “File” and “Edit” as well as the column headings “Name”, “Size” and “Type” of a table of a sample application program, part b) the system menu of the operating system OS with the Look&Feel-selection (or style-selection) and part c) the sub-menu “Edit” with the entries “Undo”, “Redo”, Cut”, “Copy”, “Paste” and “Select All” of the main menu of the same application as shown in part a).

Claims 10 to 16 concern the display of at least one part of the user interface of the operating system of a programmable unit on a display unit with discrete pixels, where claims 10 to 11 concern all kinds of display units with discrete pixels and claims 12 to 14 concern only those display units containing means to display their images with an arbitrary number h (h integer and h>1) different horizontal physical resolutions HPA₁, . . . , HPAₕ and/or an arbitrary number v (v integer and v>1) different vertical physical resolutions VPA₁, . . . , VPAᵥ, where programmable unit RE with operating system according to one of the claims 10 to 16 can use as unit M to specify the geometric width BT and/or geometric height HT of part T for example 1 meter (1 m), 1 centimeter (1 cm) or 1 millimeter (1 mm), parts of the physical width resp. height of the display of display unit A or any other physical length unit.

A programmable unit RE with operating system according to one of the claims 10 to 11 allows to specify the definition of part T independently of the physical resolution of display unit A, such that, after exchange of display unit A by another display unit A′ with other horizontal and vertical physical resolutions HPA′ resp. VPA′, part T is displayed on both display units A and A′ in—with an accuracy limited only by different digitalization errors due to the different physical resolutions—the same physical width BT and the same physical height HT.

A programmable unit RE with operating system according to one of the claims 12 to 13 allows, to display part T independent of the currently selected physical resolution of display unit A always in a readable and manipulable size, in contrast to all prior art operating systems known to the author, which store and display all user interface elements of operating system OS and/or application programs AP₁, . . . , APₐₚ in absolute pixels, such that with increasing physical resolution the physical size of the displayed user interface elements shrinks causing the user interface elements to become increasingly difficult to read and manipulate.

A programmable unit RE with operating system according to claim 14 allows the user to define for at least one part T of the user interface elements of operating system OS and/or application programs AP₁, . . . , APₐₚ, managed by operating system OS and visible on display unit A, at least one horizontal and/or vertical scaling factor, which scaling factor(s) allow(s) to chose the physical width resp. height of the image of part T on display unit A, where the number of horizontal pixels HPP can be calculated by an arbitrary function in dependence of the geometric width BT of part T, the horizontal physical resolution HPA of display unit A and the scaling factor HS and where the number of vertical pixels VPP can be calculated by an arbitrary function of the geometric height HT of part T, the vertical physical resolution VPA of display unit A and the scaling factor VS. In a special incarnation the calculation of the number of horizontal and vertical pixels HPP resp. VPP follows Formula 1,

HPP=INT(BT·HPA·HS)

VPP=INT(HT·VPA·VS) (1)

where for example BT resp. HT are given in meters, HPA resp. VPA in number of pixels per meter, HS resp. VS are arbitrary positive real numbers, and INT(x) represents the integer part of the rounded real number x.

If the user specifies only one of the two scaling factors HS and VS explicitly, the other scaling factor can be determined by unit RE and/or operating system OS from a predefined default value (like 1.0) or the currently selected value.

It is advantageous to display a horizontal resp. vertical gauge unit of predefined geometric target length during the entry of the scaling factors HS resp. VS to give the user the possibility to measure the actual physical length of the displayed gauge unit and to reproducibly adjust the physical length of the currently displayed gauge unit to any desired final geometric length.

It is especially advantageous to offer an additional entry possibility for the physical resolution HPA resp. VPA and—to measure the physical resolution HPA resp. VPA—to display an horizontal resp. vertical gauge unit with known number of pixels on display unit A, so that the user can measure the actual geometric length of the displayed gauge unit in order to determine the physical resolution HPA resp. VPA with best possible accuracy.

The measurement of the physical resolution HPA resp. VPA can also be performed automatically, if display unit A comprises additional means for the determination of the physical length(s) of the displayed gauge units, and to offer the possibility for programmable unit RE resp. operating system OS to read the measured physical lengths, such that operating system OS can calculate the physical resolution of display unit A in dependence of the physical lengths as well as the known number of pixels of the gauge units displayed on display unit A.

The measurement of the physical resolution HPA resp. VPA can also be performed automatically by an imaging device (like: a normal or a CCD-camera), which maps the image of at least one part of display unit A with a previously known scaling factor AM, and comprises means to transmit the recorded image of display unit A to programmable unit RE resp. operating system OS, such that operating system OS can determine the physical length of the image and calculate the physical resolution of display unit A in dependence of the physical length of the image, the scaling factor AM as well as the known number of pixels of the gauge displayed unit on display unit A.

The measured or specified horizontal resp. vertical physical resolutions of display unit A can also be transmitted automatically to programmable unit RE via an arbitrary physical interface from display unit A or another physical length measurement device.

A programmable unit RE with operating system according to claim 15 allows to switch between different physical resolutions immediately after selection of a new resolution by user B at run-time of the operating system OS and/or application programs AP₁, . . . , APₐₚ and does neither require the user to log-off, nor to terminate the operating system nor to terminate any application program AP₁, . . . , APₐₚ.

If a programmable unit RE with operating system according to one of the claims 11 and 13 comprises additionally means to receive after a modification of the geometric width BT and/or geometric height HT of part T, stored in storage SSE and currently used by programmable unit RE, in at least one message the updated geometric width BT and/or geometric height HT, programmable unit RE can automatically update the displayed part T to the new updated geometric width BT and/or geometric height HT, whereby it is not important how and/or with which protocol programmable unit RE is informed about the change of a given geometric width BT and/or geometric height HT of part T. This could be performed for example

1. by regular polling of service unit SE by programmable unit RE, or

2. by registering a trigger on the geometric dimensions of part T by programmable unit RE at service unit SE and automatic update notifications from service unit SE to programmable unit RE, if the geometric dimensions of part T are changed, or

3. an asynchronous update notification (without previous registered trigger) upon modification of the geometric dimensions of part T, currently used by programmable unit RE, from service unit SE to programmable unit RE.

Neither is it important in which manner and/or with which protocol and/or format programmable unit RE receives the updated geometric width BT and/or geometric height HT of part T from service unit. This could be performed for example

1. by a synchronous or asynchronous transmission of the modified geometric width BT and/or geometric height HT of part T together with the update notification from service unit SE to programmable unit RE, or

2. —after reception of the update notification—by explicit request of the modified geometric width BT and/or geometric height HT of part T from programmable unit RE to service unit SE followed by the transmission of the modified geometric width BT and/or geometric height HT of part T from service unit SE to programmable unit RE, or

3. —after reception of the update notification—by a separate synchronous or asynchronous transmission of the modified geometric width BT and/or geometric height HT of part T from service unit SE to programmable unit RE,

where programmable unit RE in the case of asynchronous message transmission from service unit SE to programmable unit RE has to comprise additional means to receive and process asynchronous messages from service unit SE.

FIGS. 17 to 19 illustrates the bitmaps of the logon screens of operating system OS at resolutions of 1024×768 (FIG. 17), 800×600 (FIG. 18) and 640×480 (FIG. 19) pixels. The printed images are of different size, because the printed pixel dimensions are fixed and cannot be adjusted to the actual size of the pixels displayed on display unit A, while each of the logon screen bitmaps shown in FIGS. 17 to 19 fills the entire display area of display unit A.

FIG. 20 directly compares the same section of the logon screen bitmaps shown in FIGS. 17 to 19 in all three resolutions, where the bitmaps were scaled to the same physical printing size, i.e. the 640×480-bitmap was enlarged by a factor 1.6 and the 800×600-Bitmap by a factor 1.28 to the same printing size as the 1024×768-bitmap. The sub-sections on the right each present a small detail of the main image—a circle with shadow and one part of the character “S” of the string “SPINetS”—in 4-fold further enlargement. The image elements have—up to an accuracy limited by their respective digitalization error—the same physical size as well as—obvious by the different edge structures—with increasing resolution an increasing geometric accuracy.

To compare prior art operating systems and operating systems with user interfaces according one of the claims 10 to 16 of the present invention the height of the title bar, the size of the title with the text “SPINetS-Logon” of the logon-dialog, the width of the dialog frame and the diameter of the black points in the corners of the logo-window as well as the “SPINetS”—window are displayed in all resolutions with the same number of pixels—like prior art operating systems—and clearly demonstrate with increasing resolution the shrinking physical dimensions of the elements (i.e. the physical height of the titlebar and the title “SPINetS-Logon”, the physical width of the window frame and the diameter of the black points in the window corners).

The lacking sharpness—especially of the enlarged figures (i.e. with original resolution 640×480 and 800×600)—is an artifact only caused by the technical limitations of the scaling algorithm used by the image processing software.

Programmable units with operating systems according to one of the claims 10 to 13 can be realized in analogy to FIGS. 11 to 14, where the parameter in at least one Look&Feel, like the height HT or width BT of part T, is stored in a resolution independent length unit M either in storage S on unit RE or in storage SSE on service unit SE and transmitted via network N upon request by programmable unit RE from service unit SE to programmable unit RE.

I claim:

1. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, whereby
i. at least said unit RE and/or operating system OS comprise(s) means to store in storage S at least one part TR of the resources R required by operating system OS and/or application programs AP₁, . . . , APₐₚ to display at least one part T of the user interface elements administered by operating system OS and displayed on display unit A in an arbitrary number n (n integer and n>1) of different languages SP₁, . . . , SPₙ, and
ii. at least said unit RE and/or operating system OS comprise(s) means to display on at least display unit A for at least one user B at least one selection possibility between at least two different languages SPᵢ and SPⱼ of said languages SP₁, . . . , SPₙ, to read via input unit E at least one language choice of user B, and to display on display unit A—after selection of language SPᵢ—at least part T in language SPᵢ and—after selection of language SPⱼ—at least part T in language SPⱼ.

2. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, whereby
i. at least said unit RE and/or operating system OS comprise(s) means to store in storage S at least one part TR of the resources R required by operating system OS and/or application programs AP₁, . . . , APₐₚ to display at least one part T of the user interface elements administered by operating system OS and displayed on display unit A in at least one language SP, and to automatically translate upon request at least part TR of the required resources R from language SP into at least one other language SPᵢ of an arbitrary number n (n integer and n≧1) of different languages SP₁, . . . , SPₙ, and
ii. at least said unit RE and/or operating system OS comprise(s) means to display on at least display unit A for at least one user B at least one selection possibility between at least two different languages SPᵢ and SPⱼ of the languages SP, SP₁, . . . , SPₙ, to read via input unit E at least one language choice of user B, and to display on display unit A—after selection of language SPᵢ—at least part T in language SPᵢ and—after selection of language SPⱼ—at least part T in language SPⱼ.

3. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, and where programmable unit RE is physically connected via at least one network interface NIRE to at least one network N, and where at least one service unit SE is physically connected via at least one network interface NISE to said network N, and where service unit SE has access to storage SSE, whereby
i. at least said service unit SE comprises means to store in storage SSE at least one part TR of the resources R required by operating system OS and/or application programs AP₁, . . . , APₐₚ to display at least one part T of the user interface elements administered by operating system OS and displayed on display unit A in an arbitrary number n (n integer and n>1) of different languages SP₁, . . . , SPₙ, and to send at least said part TR upon request of at least unit RE in the requested language via network N to unit RE, and
ii. at least said unit RE and/or operating system OS comprise(s) means to display on at least display unit A for at least one user B at least one selection possibility between at least two different languages SPᵢ and SPⱼ of languages SP₁, . . . , SPₙ, to read via input unit E at least one language choice of user B, and—after selection of language SPᵢ—to request and receive from service unit SE at least part TR of the required resources R in language SPᵢ and to display part T in language SPᵢ on display unit A as well as—after selection of language SPⱼ—to request and receive from service unit SE at least part TR of the required resources R—after selection of language SPⱼ—in language SPⱼ and to display part T in language SPⱼ on display unit A.

4. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, and where said unit RE is physically connected via at least one network interface NIRE to at least one network N, and where at least one service unit SE is physically connected via at least one network interface NISE to said network N, and where service unit SE has access to storage SSE, whereby
i. at least said service unit SE comprises means to store in storage SSE at least one part TR of the resources R required by operating system OS and/or application programs AP₁, . . . , APₐₚ to display at least one part T of the user interface elements administered by operating system OS and displayed on display unit A in at least one language SP, and to automatically translate upon request of at least programmable unit RE at least part TR of said resources R from language SP into at least one other language SPᵢ out of an arbitrary number n (n integer and n≧1) of different languages SP₁, . . . , SPₙ, and to transmit the translated resources R via network N to unit RE, and
ii. at least said unit RE and/or operating system OS comprise(s) means to display on at least display unit A for at least one user B at least one selection possibility between at least two different languages SPᵢ and SPⱼ of languages SP, SP₁, . . . , SPₙ, to read via input unit E at least one language choice of user B, and—after selection of language SPᵢ—to request and receive from service unit SE at least part TR of the required resources R in language SPᵢ and to display part T in language SPᵢ on display unit A as well as—after selection of language SPⱼ—to request and receive from service unit SE at least part TR of the required resources R—after selection of language SPⱼ—in language SPⱼ and to display part T in language SPⱼ on display unit A.

5. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, and where said unit RE is physically connected via at least one network interface NIRE with at least one network N, and where at least one service unit SE is physically connected via at least one network interface NISE with said network N, and where service unit SE has access to storage SSE, whereby
i. at least said service unit SE comprises means to store in storage SSE at least one part TR of the resources R required by operating system OS and/or application programs AP₁, . . . , APₐₚ to display at least one part T of the user interface elements administered by operating system OS and displayed on display unit A in at least one language SP, and to send at least said part TR upon request of at least unit RE in the language SP via network N to unit RE, and
ii. at least said unit RE and/or operating system OS comprise(s) means to display on at least display unit A for at least one user B at least one selection possibility between at least two different languages SPᵢ and SPⱼ of languages SP and an arbitrary number n (n integer and n≧1) of different languages SP₁, . . . , SPₙ, to read via input unit E at least one language choice of user B, and—after selection of language SPᵢ13 to request and receive at least part TR of the required resources R from service SE and, if necessary, to automatically translate part TR from language SP into language SPᵢ, to build up part T in language SPᵢ and to display part T in language SPᵢ on display unit A and—after selection of language SPⱼ—to request and receive at least part TR of the required resources R from service SE and, if necessary, to automatically translate part TR from language SP into language SPⱼ, to build up part T in language SPⱼ and to display part T in language SPⱼ on display unit A.

6. Programmable unit RE with operating system according to one of the claims 1 to 5, whereby
said unit RE comprises means to switch-over to the selected language immediately after the user selection of the new language and at run-time of the operating system OS and/or the application programs AP₁, . . . , APₐₚ—in explicite without termination of operating system OS, without termination of at least one of the applications AP₁, . . . , APₐₚ and without termination of the user's operating system session (i.e. without log-off)—.

7. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, whereby
i. at least said unit RE and/or operating system OS comprise(s) means to store in storage S and to access at least the graphical description (look) and response characteristics (feel) of an arbitrary number n (n integer and n>1) of different Look&Feels LF₁, . . . , LFₙ, and
ii. at least operating system OS comprises means to display on at least display unit A for at least one user B at least one selection possibility between at least two different Look&Feels LFᵢ and LFⱼ of said Look&Feels LF₁, . . . , LFₙ, to receive via input unit E at least one Look&Feel selection of user B, and—after selection of Look&Feel LFᵢ—to display at least part T of the user interface elements of operating system OS and/or application programs AP₁, . . . , APₐₚ, managed by operating system OS and visible on display unit A, in Look&Feel LFᵢ on display unit A and to interpret the user input via input unit E for part T in Look&Feel LFᵢ and—after selection of Look&Feel LFⱼ—to display at least part T of the user interface elements of operating system OS and/or application programs AP₁, . . . , APₐₚ, managed by operating system OS and visible on display unit A, in Look&Feel LFⱼ on display unit A and to interpret the user input via input unit E for part T in Look&Feel LFⱼ.

8. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on said display unit A at least one user interface, and where said operating system OS comprises means to receive user input via said input unit E, and where said operating system OS comprises means to execute an arbitrary number ap (ap integer and ap≧0) of application programs AP₁, . . . , APₐₚ, and where said unit RE is physically connected via at least one network interface NIRE with at least one network N, and where at least one service unit SE is physically connected via at least one network interface NISE with said network N, and where service unit SE has access to storage SSE, whereby
i. at least service unit SE comprises means to store in storage SSE the graphical description (look) and response characteristics (feel) of an arbitrary number n (n integer and n>1) of different Look&Feels LF₁, . . . , LFₙ and to transmit upon request of said unit RE the graphical description (look) and response characteristics (feel) of the requested Look&Feel to the requesting unit RE, and
ii. at least said unit RE and/or operating system OS comprise(s) means to display on at least display unit A for at least one user B at least one selection possibility between at least two different Look&Feels LFᵢ and LFⱼ of said Look&Feels LF₁, . . . , LFₙ, to read via input unit E at least one Look&Feel-selection of user B, and—after selection of Look&Feel LFᵢ—to request and receive from service unit SE the graphical description (look) and response characteristics (feel) of the selected Look&Feel LFᵢ, to display at least one part T of the user interface elements of operating system OS and/or application programs AP₁, . . . , APₐₚ, managed by operating system OS and visible on display unit A, in Look&Feel LFᵢ on display unit A and to interpret the user input via input unit E for part T in Look&Feel LFᵢ, and—after selection of Look&Feel LFⱼ—to request and receive from service unit SE the graphical description (look) and response characteristics (feel) of the selected Look&Feel LFⱼ, to display at least one part T of the user interface elements of operating system OS and/or application programs AP₁, . . . , APₐₚ, managed by operating system OS and visible on display unit A, in Look&Feel LFⱼ on display unit A and to interpret the user input via input unit E for part T in Look&Feel LFⱼ.

9. Programmable unit RE with operating system according to one of the claims 7 to 8, whereby
said unit RE comprises means to switch-over to the selected Look&Feel immediately after the user selection of the new Look&Feel and at run-time of the operating system OS and/or the application programs AP₁, . . . , APₐₚ—in explicite without termination of operating system OS, without termination of at least one of the applications AP₁, . . . , APₐₚ and without termination of the user's operating system session (i.e. without log-off).

10. Programmable unit RE with operating system comprising at least one central processing unit CPU, at least one storage S and at least one display unit A and comprising means to control said programmable unit RE by at least one operating system OS executed by said central processing unit CPU, where said operating system OS comprises means to display on said display unit A at least one user interface, and where said operating system OS comprises means to execute an arbitrary number ap (ap integer and ap≧0) of application programs AP₁, . . . , APₐₚ, and where the display of said display unit A is divided into discrete picture elements (pixels), whereby
i. at least programmable unit RE comprises means to store in storage S at least the geometrical width BT and the geometrical height HT of at least one part T of the user interface elements of operating system OS and/or application programs AP₁, . . . , APₐₚ, managed by operating system OS and visible on display unit A, in at least one unit M independent of the horizontal physical resolution HPA and the vertical physical resolution VPA of said display unit A, and
ii. at least programmable unit RE and/or operating system OS comprise(s) means to calculate from said geometric width BT—with at least an accuracy given by the horizontal physical resolution HPA—in dependence of the horizontal physical resolution HPA of display unit A the number of horizontal pixels HPP and from said geometric height HT—with at least an accuracy given by the vertical physical resolution VPA—in dependence of the vertical physical resolution VPA of display unit A the number of vertical physical pixels VPP, and to display part T with a width of HPP pixels and a height of VPP pixels on display unit A.

11. Programmable unit RE with operating system comprising at least one central processing unit CPU, at least one storage S and at least one display unit A and comprising means to control said programmable unit RE by at least one operating system OS executed by said central processing unit CPU, where said operating system OS comprises means to display on said display unit A at least one user interface, and where said operating system OS comprises means to execute an arbitrary number ap (ap integer and ap≧0) of application programs AP₁, . . . , APₐₚ, and where the display of said display unit is divided into discrete picture elements (pixels), and where said unit RE is physically connected via at least one network interface NIRE with at least one network N, and where at least one service unit SE is physically connected via at least one network interface NISE with said network N, and where service unit SE has access to storage SSE, whereby
i. at least service unit SE comprises means to store in storage SSE at least the geometric width BT and the geometric height HT of at least one part T of the user interface elements of operating system OS and/or application programs AP₁, . . . , APₐₚ, managed by operating system OS and visible on display unit A, in at least one unit M independent of the horizontal physical resolution HPA and the vertical physical resolution VPA of display unit A and to transmit upon request of at least said unit RE at least the geometric width BT and the geometric height HT of at least one part T to the requesting unit RE, and
ii. —to display at least part T on display unit A—at least said unit RE and/or operating system OS comprise(s) means to request and receive from said service unit SE at least the geometric width BT and geometric height HT of said part T, to calculate from said geometric width BT—with at least an accuracy given by the horizontal physical resolution HPA—in dependence of the horizontal physical resolution HPA of display unit A the number of horizontal pixels HPP and from said geometric height HT—with at least an accuracy given by the vertical physical resolution VPA—in dependence of the vertical physical resolution VPA of display unit A the number of vertical physical pixels VPP, and to display part T with a width of HPP pixels and a height of VPP pixels on display unit A.

12. Programmable unit RE with operating system comprising at least one central processing unit CPU, at least one storage S, at least one display unit A and at least one input unit E and comprising means to control said unit RE by at least one operating system OS executed by said central processing unit CPU, where said operating system OS comprises means to display on said display unit A at least one user interface, and where said operating system OS comprises means to receive user input via said input unit E, and where the display of said display unit is divided into discrete picture elements (pixels), and where display unit A comprises means to display the image in at least one physical resolution out of an arbitrary number h (h integer and h>1) of different horizontal physical resolutions HPA₁, . . . , HPAₕ and/or out of an arbitrary number v (v integer and v>1) vertical physical resolutions VPA₁, . . . , VPAᵥ, and where at least operating system OS comprises means to display on at least display unit A for at least one user B at least one selection possibility between at least two different resolutions PAᵢ and PAⱼ of the horizontal and/or vertical physical resolutions HPA₁, . . . , HPAₕ, VPA₁, . . . , VPAᵥ and to accept via said input unit E from user B the choice of at least one horizontal physical resolution HPA and at least one vertical physical resolution VPA of the selectable physical resolutions, and where said operating system OS comprises means to execute an arbitrary number ap (ap integer and ap≧0) of application programs AP₁, . . . , APₐₚ, whereby
i. at least said unit RE comprises means to store in storage S at least the geometric width BT and the geometric height HT of at least one part T of the user interface elements of operating system OS and/or application programs AP₁, . . . , APₐₚ, managed by operating system OS and visible on display unit A, in at least one unit M independent of all horizontal physical resolutions HPA₁, . . . , HPAₕ and all vertical physical resolutions VPA₁, . . . , VPAᵥ, and
ii. —to display at least part T on display unit A—at least said unit RE and/or operating system OS comprise(s) means to display after selection of horizontal physical resolution HPA and vertical physical resolution VPA the user interface elements of operating system OS and of application programs AP₁, . . . , APₐₚ in the selected horizontal and vertical physical resolutions HPA and VPA on display unit A, where at least part T is displayed in at least two selectable horizontal physical resolutions—with at least an accuracy given by the selected horizontal physical resolution of display unit A—with identical geometric width BT and in at least two selectable vertical physical resolutions—with at least an accuracy given by the selected vertical physical resolution of display unit A—with identical geometric height HT.

13. Programmable unit RE with operating system comprising at least one central processing unit CPU, at least one storage S, at least one display unit A and at least one input unit E and comprising means to control said programmable unit RE by at least one operating system OS executed by said central processing unit CPU, where said operating system OS comprises means to display on at least display unit A at least one user interface, and where said operating system OS additionally comprises means to receive user input via said input unit E, and where the display of said display unit A is divided into discrete picture elements (pixels), and where display unit A comprises means to display the image in at least one physical resolution out of an arbitrary number h (h integer and h>1) of different horizontal physical resolutions HPA₁, . . . , HPAₕ and/or of an arbitrary number v (v integer and v>1) vertical physical resolutions VPA₁, . . . , VPAᵥ, and where at least operating system OS comprises means to display on at least display unit A for at least one user B at least one selection possibility between at least two different resolutions PAᵢ and PAⱼ of said horizontal and/or vertical physical resolutions HPA₁, . . . , HPAₕ, VPA₁, . . . , VPAᵥ and to receive from user B via input unit E the selection of at least one horizontal physical resolution HPA and at least one vertical physical resolution VPA of the selectable physical resolutions, and where said operating system OS comprises means to execute an arbitrary number ap (ap integer and ap≧0) of application programs AP₁, . . . , APₐₚ, and where programmable unit RE is physically connected via at least one network interface NIRE with at least one network N, and where at least one service unit SE is physically connected via at least one network interface NISE with said network N, and where service unit SE has access to storage SSE, whereby
i. at least said service unit SE comprises means to store in storage SSE at least the geometric width BT and the geometric height HT of at least one part T of the user interface elements of operating system OS and/or application programs AP₁, . . . , APₐₚ, managed by operating system OS and visible on display unit A, in at least one unit M independent of all horizontal physical resolutions HPA₁, . . . , HPAₕ and all vertical physical resolutions VPA₁, . . . , VPAᵥ and to transmit upon request of at least said unit RE at least the geometric width BT and the geometric height HT of at least one part T to the requesting unit RE, and
ii. at least said unit RE and/or operating system OS comprise(s) means—to display at least part T on display unit A—to request and receive from service unit SE at least the geometric width BT and the geometric height HT of part T and to display—after selection of horizontal physical resolution HPA and vertical physical resolution VPA—the user interface elements of operating system OS and of application programs AP₁, . . . , APₐₚ in the selected horizontal and vertical physical resolutions HPA and VPA on display unit A, where at least part T is displayed in at least two selectable horizontal physical resolutions—with at least an accuracy given by the selected horizontal physical resolution of display unit A—with identical geometric width BT and in at least two selectable vertical physical resolutions—with at least an accuracy given by the selected vertical physical resolution of display unit A—with identical geometric height HT.

14. Programmable unit RE with operating system according to one of the claims 10 to 13, additionally comprising at least one input unit E, where said operating system OS additionally comprises means to receive user input via said input unit E, whereby
i. at least said unit RE and/or operating system OS comprise(s) means to offer at least one possibility to at least one user B to enter a horizontal scaling factor HS and/or vertical scaling factor VS and to read the horizontal scaling factor HS and/or vertical scaling factor VS entered by user E via input unit E, and
ii. at least said unit RE and/or operating system OS comprise(s) means—to display at least part T on display unit A—to calculate from the geometric width BT—with at least an accuracy given by horizontal physical resolution HPA—the number of horizontal physical pixels HPP in dependence of said scaling factor HS and the horizontal physical resolution HPA of display unit A, to calculate from the geometric height HT—with at least an accuracy given by vertical physical resolution VPA—the number of vertical physical pixels VPP in dependence of the scaling factor VS and the vertical physical resolution VPA of display unit A, and to display part T with a width of HPP pixel and a height of VPP pixels on display unit A.

15. Programmable unit RE with operating system according to claim 14, whereby said unit RE comprises means to switch-over to the selected scaling factor(s) immediately after the user selection of a new horizontal and/or vertical scaling factor at run-time of the operating system OS and/or the application programs AP₁, . . . , APₐₚ—in explicite without termination of operating system OS, without termination of at least one of the applications AP₁, . . . , APₐₚ and without termination of the user's operating system session (i.e. without log-off).

16. Programmable unit RE with operating system according to one of the claims 12 to 15, whereby
said unit RE comprises means to switch-over to the selected physical resolution(s) immediately after the user selection of a new horizontal and/or vertical physical resolution and at run-time of the operating system OS and/or the application programs AP₁, . . . , APₐₚ—in explicite without termination of operating system OS, without termination of at least one of the applications AP₁, . . . , APₐₚ and without termination of the user's operating system session (i.e. without log-off).
